(19) United States
(12) Patent Application Publication
(10) Pub. No.: US 2025/0245074 A1
(43) Pub. Date: Jul. 31, 2025

(54) INFORMATION PROCESSING APPARATUS, DATA REGISTRATION SYSTEM, AND DATA REGISTRATION METHOD

(71) Applicant: Seiichi KONDO, Tokyo (JP)

(72) Inventor: Seiichi KONDO, Tokyo (JP)

(21) Appl. No.: 19/023,629

(22) Filed: Jan. 16, 2025

(30) Foreign Application Priority Data
Jan. 26, 2024 (JP) 2024-010508

(51) Int. Cl. G06F 9/54; H04L 51/02; H04L 51/046

(52) U.S. Cl. CPC G06F 9/54; H04L 51/02; H04L 51/046; G06F 2209/547

(57) ABSTRACT

An information processing apparatus communicably connects with a terminal device and a generative artificial intelligence (AI) system through a network. Processing circuitry transmits the chat message to the generative AI system in response to receiving a chat message from the terminal device. The processing circuitry transmits at least once, to the generative AI system, information related to an application in which data is to be registered and information for the generative AI system to call a function. The processing circuitry executes the function to register the data in the application in response to receiving a request transmitted by the generative AI system based on the chat message, the information related to the application, and the information for calling the function, execute the function to register the data in the application. The data is included in the request and generated by the generative AI system.

### CROSS-REFERENCE TO RELATED APPLICATIONS

This patent application is based on and claims priority pursuant to 35 U.S.C. § 119 (a) to Japanese Patent Application No. 2024-010508, filed on Jan. 26, 2024, in the Japan Patent Office, the entire disclosure of which is hereby incorporated by reference herein.

### BACKGROUND

### Technical Field

The present disclosure relates to an information processing apparatus, a data registration system, and a data registration method.

### Related Art

The generative artificial intelligence (AI) generates a response requested by a chat message from a user. As an example of a usage of the generative AI, the user may request the generative AI to generate data.

### SUMMARY

Embodiments of the present disclosure described herein provide an information processing apparatus communicably connected with a terminal device and a generative artificial intelligence (AI) system through a network. The apparatus includes processing circuitry. The processing circuitry transmits the chat message to the generative AI system in response to receiving a chat message from the terminal device. The processing circuitry transmits at least once, to the generative AI system, information related to an application in which data is to be registered and information for the generative AI system to call a function. The processing circuitry executes the function to register the data in the application in response to receiving a request transmitted by the generative AI system based on the chat message, the information related to the application, and the information for calling the function, execute the function to register the data in the application. The data is included in the request and generated by the generative AI system based on the chat message and the information related to the application.

Embodiments of the present disclosure described herein provide a data registration system including a terminal device and an information processing apparatus. The terminal device includes terminal circuitry. The terminal circuitry transmits a chat message for registering data to be used by an application. The information processing apparatus communicably connects with the terminal device and a generative AI system through a network. The information processing apparatus includes processing circuitry. The processing circuitry transmits the chat message to the generative AI system in response to receiving the chat message from the terminal device. The processing circuitry transmits at least once, to the generative AI system, information related to the application in which data is to be registered and information for the generative AI system to call a function. The processing circuitry executes the function to register the data in the application in response to receiving a request transmitted by the generative AI system based on the chat message, the information related to the application, and the information for calling the function, execute the function to register the data in the application. The data is included in the request and generated by the generative AI system based on the chat message and the information related to the application.

Embodiments of the present disclosure described herein provide a data registration method, executed by an information processing apparatus communicably connected with a terminal device and a generative AI system through a network. The method includes: in response to receiving a chat message from the terminal device, transmitting the chat message to the generative AI system; transmitting at least once, to the generative AI system, information related to an application in which data is to be registered and information for the generative AI system to call a function; and in response to receiving a request transmitted by the generative AI system based on the chat message, the information related to the application, and the information for calling the function, executing the function to register the data in the application, the data being included in the request and generated by the generative AI system based on the chat message and the information related to the application.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a user interface of an application;

FIGS. 2A to 2C are diagrams illustrating various graphs generated by a daily report application that processes dummy data;

FIG. 3 is a diagram illustrating processing from when a generative AI system requests an information processing system to execute a function in response to a chat message input by the user until when the information processing system generates dummy data;

FIG. 4 is a diagram illustrating a system configuration of a data registration system;

FIG. 5 is a diagram illustrating a hardware configuration of the information processing system, a user terminal, and a developer terminal;

FIG. 6 is a diagram illustrating a functional configuration of the information processing system, the user terminal, and the developer terminal;

FIG. 7 is a diagram illustrating a daily report application screen displayed by the user terminal;

FIG. 8 is a diagram illustrating a function selection screen displayed when the user presses an AI cooperating function button;

FIG. 9 is a diagram illustrating a chat screen displayed when the user presses an automatic record generation button;

FIG. 10 is a diagram illustrating a chat screen on which generated dummy data is displayed;

FIG. 11 is a diagram illustrating a daily report application screen and a chat screen displayed when the user presses an OK button;

FIG. 12 is a diagram illustrating a response message acquired from an application service by the information processing system;

FIG. 13 is a diagram illustrating a request message for calling a first application programming interface (API) published by the generative AI system;

FIG. 14 is a diagram illustrating a response message transmitted from the generative AI system to the information processing system in response to the request message of FIG. 13;

FIG. 15 is another diagram illustrating a response message transmitted from the generative AI system to the information processing system in response to the request message of FIG. 13;

FIG. 16 is a diagram illustrating a request message transmitted to an application service by a data registration unit of the information processing system, based on a function call request of FIG. 15;

FIG. 17 is a diagram illustrating a request message for calling the first API published by the generative AI system;

FIG. 18 is a sequence diagram illustrating processing in which the information processing system supports registration of dummy data;

FIG. 19 is a sequence diagram illustrating that the information processing system utilizes the cooperation of two web browsers in the user terminal to register dummy data to an application service; and

FIG. 20 is another sequence diagram illustrating that the information processing system utilizes the cooperation of two web browsers in the user terminal to register dummy data to the application service.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of an information processing system and an application registration method performed by the information processing system as an embodiment of the present disclosure with reference to the drawings. In the present embodiment, a user can generate and register dummy data with law-code or no-code using a generative AI system.

A generative AI system such as ChatGPT® is known. The generative AI system can perform various natural language processing tasks, such as text generation, question answering, text classification, sentiment analysis, information extraction, and sentence summarization. The generative AI system such as Copilot® has been proposed, which suggests next code to be written while coding a program. The generative AI system can also generate an application with low-code or no-code.

In the present embodiment, a description is given below of a technique in which the user generates dummy data to be used in an application through a conversation (also referred to as a chat) with the generative AI system and further registers the dummy data in the application. In the following description, the generative AI system or a function of the generative AI system may be simply referred to as AI.

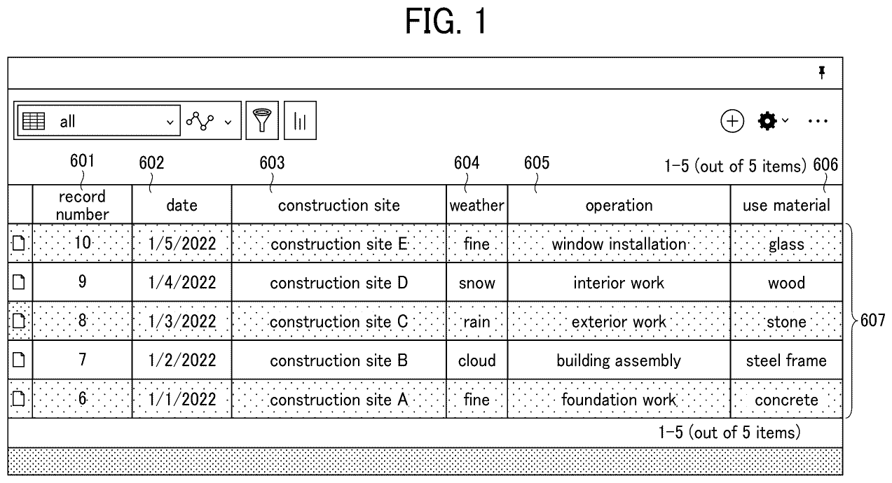

FIG. 1 is a diagram illustrating a user interface of an application. The application may be manually generated by the user or generated by the generative AI system. FIG. 1 illustrates the user interface of a daily report application related to a construction site. The daily report application is, for example, a database type application, and the daily report application can register a value of each item. The daily report application includes items of record number 601, date 602, construction site 603, weather 604, operation 605, and use material 606. The table illustrated in FIG. 1 includes five records 607 that have already been input.

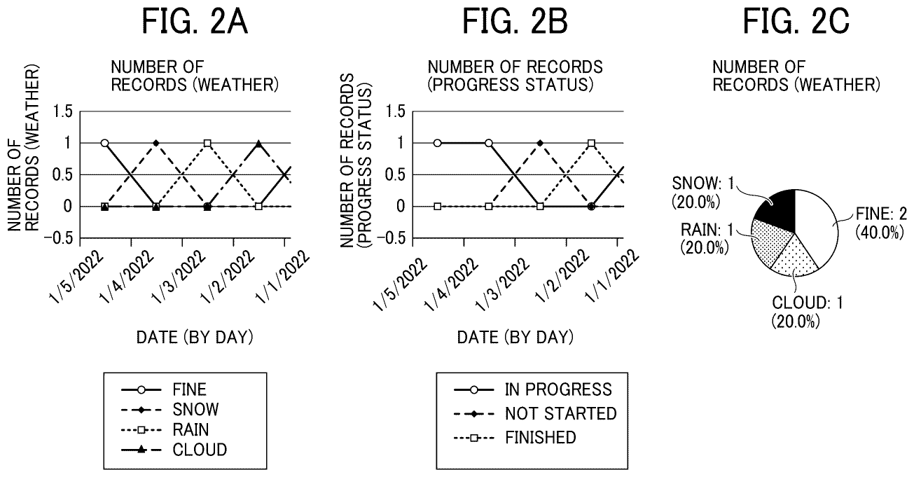

The user uses such records (data) to confirm whether the generated application is appropriate. For example, as illustrated in FIG. 2, the user needs data to check whether a graph function of the daily report application can be appropriately executed. In the present embodiment, such data is referred to as dummy data.

FIGS. 2A to 2C are diagrams illustrating various graphs generated by the daily report application that processes dummy data. FIG. 2A illustrates weather for each date, FIG. 2B illustrates progress statuses for each date, and FIG. 2C illustrates percentages of each weather. The user cannot confirm whether the daily report application operates appropriately without dummy data suitable for the daily report application. In other words, even when the user or the generative AI system generates an application, the user cannot confirm whether the application can be released.

In addition to such a graph function, various dummy data may be required to confirm whether a print result acquired by printing a record by an application and a conversion result into a portable document format (PDF) file are appropriate.

In the present embodiment, the user generates dummy data appropriate for the application through a conversation with a generative AI system 50. The generated test data is not limited to the test data of the application that is generated by the generative AI system 50, and can be used for a test of an application that is manually generated by the user.

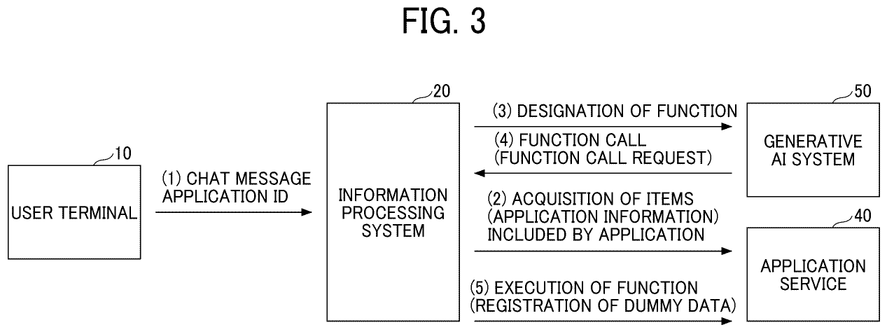

FIG. 3 is a diagram illustrating processing from when the generative AI system 50 requests an information processing system 20 to execute a function in response to a chat message input by the user until when the information processing system 20 generates dummy data. The information processing system 20 provides a user interface (UI) when the user develops an application using the generative AI system 50. The information processing system 20 is described later. The information processing system 20 converts a chat message transmitted from a user terminal 10 into a request message for calling an application programming interface (API) published by the generative AI system 50 and an application service 40, and transmits the request message to the generative AI system 50 and the application service 40.

In step (1), the user terminal 10 transmits a chat message input by the user to the information processing system 20. In the present embodiment, the chat message includes a content such as “I want the information processing system 20 to generate dummy data.” The user terminal 10 transmits identification information (referred to as an application identification (ID) in the following description) for identifying an application to the information processing system 20.

In step (2), the user terminal 10 designates the application ID to request the information processing system 20 to generate dummy data. The dummy data needs to be corresponded to the items included in the application. In the present embodiment, the information processing system 20 calls the API of the application service 40, and thus, the information processing system 20 acquires application information such as items included in the application designated by the application ID from the application service 40.

In step (3), the information processing system 20 includes the items of the application in a request message to transmit the items of the application to the generative AI system 50 via the API for receiving the request message provided by the generative AI system 50. The information processing system 20 transmits the request message including setting of a specification of a function. The function is a program interface that performs a predetermined process with specified arguments and returns a return value as a result. This function is a function for enabling the generative AI system 50 to request the information processing system 20 to generate the application used on the application service 40. The information processing system 20 includes the setting of the function specification in the request message to transmit the setting to the generative AI system 50 and thus, the information processing system 20 can generate or update the dummy data with low-code or no-code in response to the request from the generative AI system 50. The generative AI system 50 requesting the information processing system 20 to call the function is referred to as a function call. As supplementary information, the information processing system 20 can include, in the request message, system setting for notifying the generative AI system 50 of the type of dummy data. The system setting is a general policy regarding the application to be generated, whereas the setting of the function specification is information for the information processing system 20 to designate the specification of a function call to be called by the generative AI system 50 to the generative AI system 50. The system setting and the setting of the function specification are described later.

The information processing system 20 may not include the system setting and the setting of the function specification in the same request message as the items of the application. For example, the information processing system 20 may include the system setting and the setting of the function specification in a request message different from the request message including the items of the application and transmit the request message to the generative AI system 50. The information processing system 20 may also include the system setting and the setting of the function specification in different request messages to transmit the request messages to the generative AI system 50.

The information processing system 20 may transmit the system setting and the setting of the function specification each time the information processing system 20 transmits the request message including the items of the application, or may transmit the system setting and the setting of the function specification only once at the beginning.

In step (4), the generative AI system 50 transmits a response message including a function call request (function call) to the information processing system 20 based on the items of the application, the setting of the function specification, and the system setting included in the transmitted request message. The generative AI system 50 only requests the information processing system 20 to call a function, and the information processing system 20 actually executes the function. However, the generative AI system 50 includes the items of the application transmitted from the information processing system 20 in the request message.

The generative AI system 50 may not transmit the response message including the function call request to the information processing system 20 based on a history of conversation, the setting of the function specification, and the system setting. For example, the generative AI system 50 may transmit a response message including a question or a response message indicating that the content of the items of the application cannot be understood to the information processing system 20.

In step (5), the information processing system 20 requests the application service 40 to register the dummy data in response to the function call request (function call) included in the response message transmitted from the generative AI system 50. Specifically, the information processing system 20 generates a request message for calling the API of the application service 40 from the content of the function call request (function call), and transmits the generated request message to the application service 40. In the present embodiment, such a process related to the generation of a request message may be referred to as “execution of a function” or “executing a function.” In the present embodiment, the information processing system 20 generates the dummy data to be used in the application service 40 in response to the function call request (function call).

As described above, the user only inputs a request for generating dummy data to the user terminal 10, and thus the information processing system 20 can register the dummy data, which is used by the application generated by the generative AI system 50, in the application service 40.

Although the existing generative AI system can also create dummy data, the user has to instruct the generative AI system on item names. When the generative AI system returns dummy data for each item, the user needs to register the dummy data in the application service 40 one by one. On the other hand, in the present embodiment, when the user performs an operation to input a request for registering dummy data in the application, the dummy data to be used by an application can be registered in the application.

An application is an abbreviation of an application program, and is a program generated by a computer in accordance with any businesses. An operating system (OS) is general-purpose software that provides basic functions and systems (e.g., file system, communication, and display control) in the operation of a computer, whereas the application provides specific functions on the OS. Examples of the application include a native application and a web application. In the present embodiment, either a native application or a web application may be developed.

The API is an interface of the application (software), and is a contact point for connecting systems to share functions and mechanisms. The API defines the specification of an interface used by applications to exchange information with each other. The API between computers is designed so that one web site communicates with another web site via hypertext transfer protocol (HTTP) or hypertext transfer protocol secure (HTTPS) communication. Communication allows one web site to use the functions of another web site. The API between computers may be referred to as a web-API.

When the API transmits a specific request (e.g., data acquisition, update, deletion, and processing), the API returns a result (e.g., data, an update result, a deletion result, and a processing result) in response to the specific request. The request may be referred to as a request message, and the result may be referred to as a response message. Calling an API indicates transmitting a request and acquiring a result in accordance with the specification of the API. Calling an API may also be referred to as executing, operating, hitting, or using.

The information for calling a function is information that enables a function provided by the information processing system 20 to be called from the outside of the information processing system, for example, the generative AI system 50. The information for calling a function includes information related to a web-API for calling the function.

The information related to the web-API for calling the function is information for enabling the generative AI system 50 to call (use) the web-API. In the present embodiment, the term “setting of function specification” (referred to as “function specification setting” in the following description) is used to indicate the information related to the web-API for calling the function. The function specification setting is information that the information processing system 20 designates the specification of the function to be called by the generative AI system 50 to the generative AI system 50. Since the generative AI system 50 calls the function to the information processing system 20 based on the setting of function specification, the information processing system 20 can analyze the function.

The function is a program interface that performs a predetermined process with specified arguments and returns a return value as a result. A developer can design the specification and function of a function, whereas API is prepared in advance for the function that have been published as being available for use by the generative AI system 50 and the application service 40. The function is one of specifications of the API, and can be set by calling the API when the API defines a method of designating the function. Calling of a function or calling request of a function indicates a request for execution of a function.

A chat service is a service in which multiple users transmit and receive messages in real time. The generative AI system is a service in which the user transmits and receives messages to and from an AI in real time.

The setting information is an overall policy for generating an application, and the setting information is, for example, a description or a hint of the content of the application, or the content about which the user is not to be asked about. The setting information is information that facilitates generation of a desired application when the information is notified to the generative AI system 50.

The system setting is information acquired by converting all or a part of the setting information into a request message for calling an API. In other words, the system setting is information acquired by converting all or a part of the setting information into the format of the API.

The user is an end user who uses an application provided by the application service 40. The user can also develop an application. The developer is a person who performs setting to be used for application development by no-code or low-code programming on the information processing system 20. The developer sets setting information, which is described later, in the information processing system 20.

Data used by an application is data that enables the application to perform its functions. For example, in the case of an application that handles a database in a table format, the data used by the application is a value in the table, in other words, a value registered in the database. When the application is an application for creating a graph, the data used by the application is a value visualized in the graph. The data used by the application may be, for example, setting data for setting the application or data input to the application. In the present embodiment, data used by an application is described by the term “dummy data.” The dummy data may be referred to as test data or sample data.

Information about an application is information about the application necessary for registering dummy data in the application. In the present embodiment, the information is one or more of, for example, an item name, a data format, and a button name.

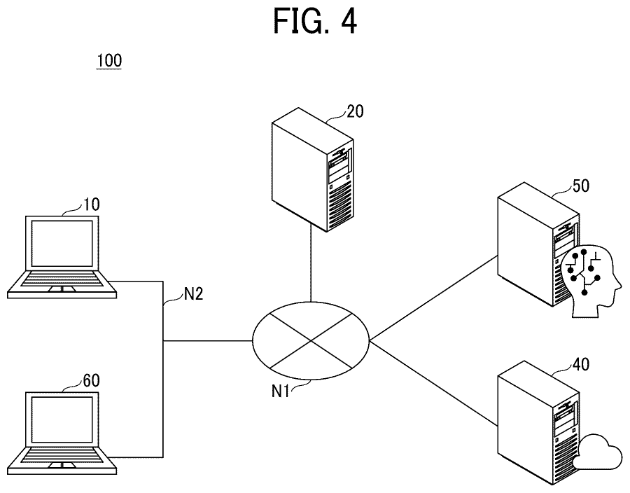

A description is given below of a system configuration of a data registration system 100 according to the present embodiment with reference to FIG. 4. FIG. 4 is a diagram illustrating the system configuration of the data registration system 100. The data registration system 100 illustrated in FIG. 4 includes the information processing system 20, the user terminal 10, and a developer terminal 60. The information processing system 20 and the user terminal 10, and the information processing system 20 and the developer terminal 60 are connected to communicate with each other via networks N1 and N2. The information processing system 20 can communicate with the generative AI system 50 and the application service 40, which is an external system, via a network N1. The user terminal 10 and the developer terminal 60 can communicate with the generative AI system 50 and the application service 40, which is an external system, via the networks N1 and N2.

The user terminal 10 and the developer terminal 60 are installed in a facility such as a facility of company and a facility of home, and are connected to a network N2. The network N2 may be a local area network, a Wi-Fi® network, a wide-area ethernet®, or a cellular network such as 4G, 5G, or 6G. The network N1 is a wide area network such as the Internet or a wide area network (WAN). The user terminal 10 and the developer terminal 60 may not be always connected to the network N2, and may be connected when the information processing system 20, the generative AI system 50, or the application service 40 is used.

The generative AI system 50 provides a service for the user to converse with an AI in a conversational manner. As a system such as the generative AI system 50, a system using large language models (LLMs) has been proposed. The LLMs are models for natural language processing that have been trained using a large amount of text data. The generative AI system 50 captures a huge amount of text in advance and learns knowledge from the text using deep learning or reinforcement learning. The generative AI system 50 uses this knowledge to provide a reply message to data based on a chat message or sample data. An interface with which the user inputs a chat message to the generative AI system 50 is called a prompt. The prompt may be input with a chat message (natural language) such as an instruction or a question or a file. The chat message may be a conversational sentence or a word composed of a natural language spoken by a human. An image may also be the chat message. The generative AI system 50 that generates a sentence for a chat message may be referred to as a generative AI. In the present embodiment, the information processing system 20 uses a reply message that the generative AI system 50 replies to the data based on the chat message input by the user to generate an application that operates on the application service 40.

The generative AI system 50 has the following features. The generative AI system 50 performs a conversation in a natural flow. The generative AI system 50 can expand ideas even in a field in which the user does not have knowledge to propose. The generative AI system 50 can output accurate program code. Accordingly, the information processing system 20 can perform a conversation with the user through the generative AI system 50 in a natural flow. The user can only designate the application to be created to receive ideas necessary for the application. Since the function called by the generative AI system 50 is accurate (high in reproducibility), the information processing system 20 easily generates the application desired by the user.

As the generative AI system 50, a system using LLM such as generative pre-trained transformer-3 (GPT-3®), GPT-4®, Transformer®, or bidirectional encoder representations from Transformers (BERT®) has been proposed. The data registration system 100 according to the present embodiment can use ChatGPT using GPT-3 or GPT-4. Alternatively, the data generation system 100 according to the present embodiment may use a system using another LLM.

The application service 40 is one or more information processing apparatuses that provide an application to be executed by the user. The application provided by the application service 40 is, for example, a database type web application that manages data in a table format. The user can set any fields of the application and can customize the application so that the user can store, read, or process data related to the customer's business. The development of the application is to set fields desired by the user in the database prepared in advance. The registration of data desired by the user in the database is the registration of the dummy data.

In the present embodiment, the information processing system 20 includes the chat message from the user in a request message and transmits the request message to the generative AI system 50. The information processing system 20 uses the response message from the generative AI system 50 to register the dummy data in the application service 40. In other words, the user can register the dummy data to be used by the application service 40 with no-code.

When the application service 40 and the information processing system 20 have different domains (e.g., when the service providers of the application service 40 and the information processing system 20 are different), the application service 40 and the information processing system 20 have different accounts even for the same user.

On the other hand, the application service 40 may be integral with the information processing system 20. In other words, the application service 40 may include the functions of the information processing system 20. Alternatively, the information processing system 20 may include the functions of the application service 40. The application service 40 may be integral with the generative AI system 50. The generative AI system 50 may be integral with the information processing system 20. The information processing system 20 may be integral with the application service 40 and the generative AI system 50.

The application service 40 is, for example, a cloud service, an application service provider (ASP), and a software as a service (SaaS), and may include various services provided via a network. The services provided via a network are, for example, a database provision service and a storage service. The application service 40 may reside on the Internet. Alternatively, the application service 40 may reside in an on-premises environment.

In the following description, when the multiple application services 40 are distinguished from each other, the multiple application services 40 is referred to as “application services 40A and 40B.”

The information processing system 20 transmits the chat message transmitted from the user terminal 10 to the generative AI system 50. The information processing system 20 includes one or more information processing apparatuses. The information processing system 20 serves as a server that receives a request from the user terminal 10. The server is a computer or software that functions to provide information or a processing result in response to a request from the client. The information processing system 20 provides a user interface to the user terminal 10, generates a request message from the received chat message, and transmits the generated request message to the generative AI system 50. When the information processing system 20 receives a registration request of the dummy data (function_call) from the generative AI system 50, the information processing system 20 requests the application service 40 to register the dummy data. Accordingly, the user does not have to connect the user terminal 10 to the generative AI system 50 or the application service 40.

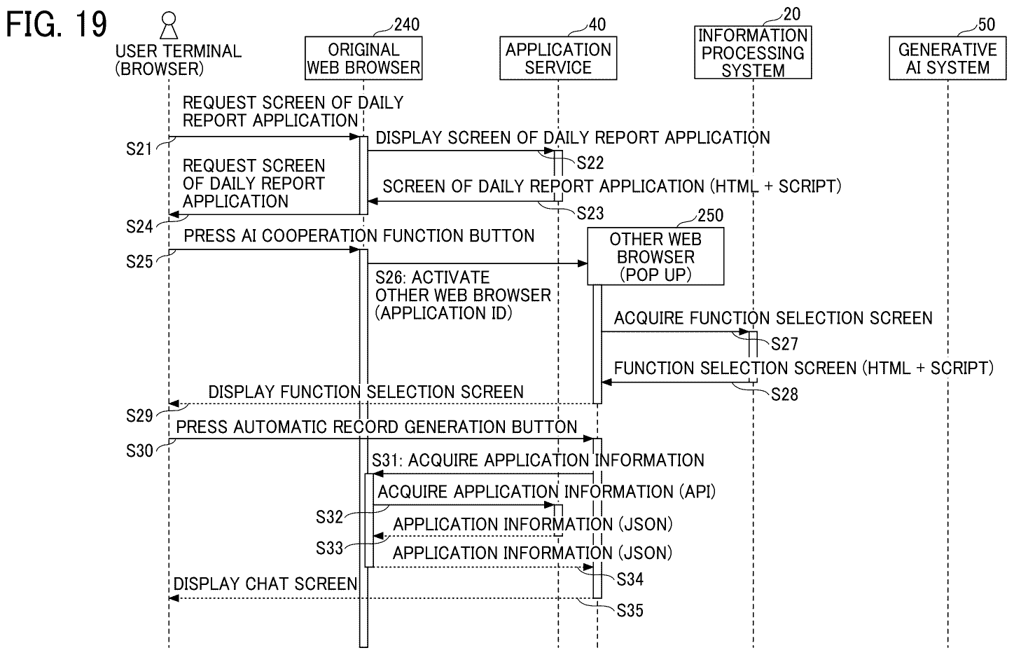

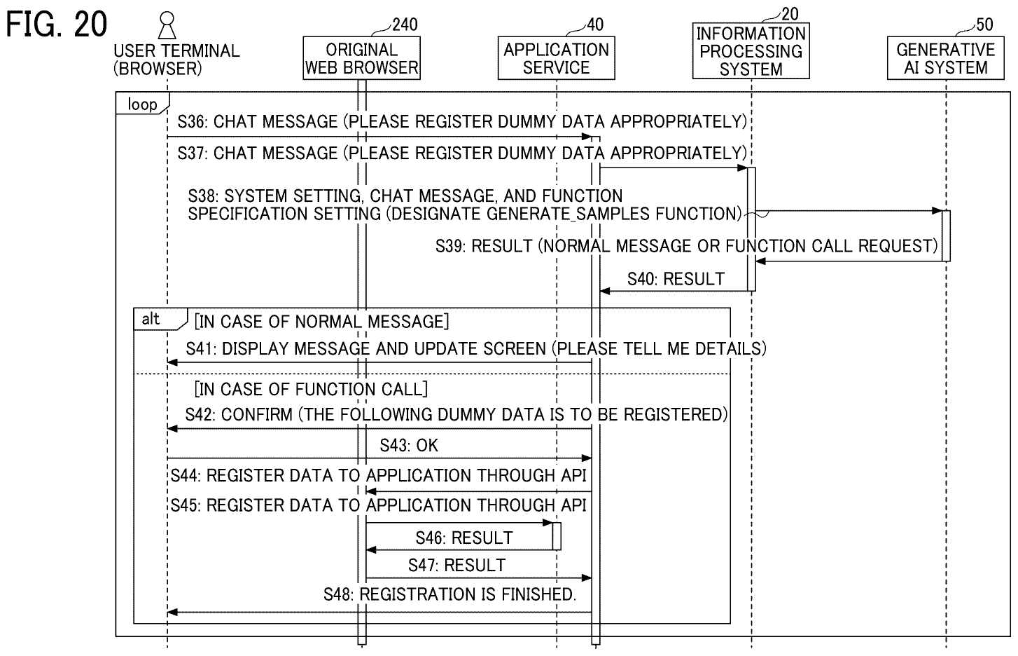

As described later, the user may register dummy data using the application service 40 as a portal. The information processing system 20 receives a connection request to the generative AI system 50 from the user terminal 10 connected to the application service 40, and communicates with the generative AI system 50. A description is given of such communication with reference to FIGS. 19 and 20.

The information processing system 20 receives setting of setting information from the developer terminal 60. The setting of the setting information is to set knowledge (setting information) to be used for generating the application or the dummy data of the application service 40 in the information processing system 20. The setting information is information that the generative AI system 50 uses to generate the dummy data of the application. The setting information may include, for example, what kind of dummy data of the application is requested to be generated. The developer sets the setting information in the information processing system 20, and thus user support is facilitated. The information processing system 20 can create appropriate system setting related to the application based on the setting information and notify the generative AI system 50 of the generated system setting. The system setting is generated from the setting information, and the system setting is part or all of the setting information.

The setting information is set in the information processing system 20 before the user starts developing the application or registering the dummy data. However, the information processing system 20 can customize the setting information for each customer. For example, when the setting information is “you will have a conversation with a customer of ABC business from now” according to the business type of the customer, the information processing system 20 changes the business type name of ABC according to the business type of the customer and notifies the generative AI system 50 of the business type name.

The information processing system 20 creates a request message to be transmitted to the generative AI system 50 using the setting information. On the other hand, in the present embodiment, the setting information may not be provided. Since the information processing system 20 can acquire the item of the application from the application service 40, the setting information may not be provided. In the request message, the setting information is reflected in the system setting described later. A detailed description is given later.

The information processing system 20 may be implemented by cloud computing. Alternatively, the information processing system 20 may be implemented by a single information processing apparatus. The “cloud computing” refers to a usage pattern in which resources on a network are used or accessed without identifying specific hardware resources. The information processing system 20 may reside on the Internet. Alternatively, the information processing system 20 may reside in an on-premises environment.

The information processing system 20 may have its functions distributed across multiple information processing apparatuses. Alternatively, the information processing system 20 may have the multiple information processing systems 20 with the same functions, and the number of the information processing system 20 may be increased or decreased depending on the processing load.

The user terminal 10 or the developer terminal 60 is, for example, a terminal device such as a personal computer (PC), a smartphone, or a tablet terminal used by the user or the developer. In the user terminal 10 or the developer terminal 60, a web browser or a native application operates. The developer operates the developer terminal 60 to generate setting information related to the application. The user operates the user terminal 10 to input a chat message. An administrator or the user can operate the developer terminal 60 and the user terminal 10 to use various services provided by the information processing system 20, the generative AI system 50, or the application service 40.

The user terminal 10 or the developer terminal 60 may be any information processing apparatus. Such an information processing apparatus includes an output apparatus such as an electronic whiteboard or a digital signage. Such an information processing apparatus also includes a head up display (HUD) apparatus, an industrial machine, an imaging apparatus, a sound collecting apparatus, a medical apparatus, a network home appliance, a mobile phone, a smartphone, a tablet terminal, a car navigation system, a game machine, a personal digital assistant (PDA), a digital camera, and a wearable PC.

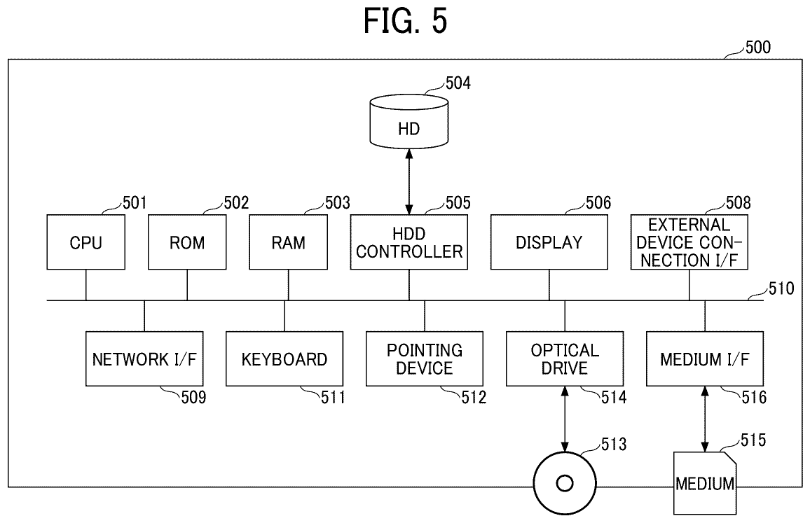

A description is given below of a hardware configuration of the information processing system 20, the user terminal 10, and the developer terminal 60 included in the data registration system 100 with reference to FIG. 5. The generative AI system 50 and the application service 40 have the same hardware configuration described in FIG. 5, or have a hardware configuration of an information processing apparatus compatible with cloud computing.

FIG. 5 is a diagram illustrating the hardware configuration of the information processing system 20, the user terminal 10, and the developer terminal 60 according to the present embodiment. As illustrated in FIG. 5, the information processing system 20, the user terminal 10, and the developer terminal 60 each are implemented by a computer 500. The computer 500 includes a central processing unit (CPU) 501, a read-only memory (ROM) 502, a random-access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, a digital versatile disk rewritable (DVD-RW) drive 514, and a medium I/F 516.

The CPU 501 controls the overall operation of the computer 500. The ROM 502 stores programs such as an initial program loader (IPL) to boot the CPU 501. The RAM 503 is used as a work area for the CPU 501. The HD 504 stores various data such as a program. The HDD controller 505 controls the reading and writing of various data from and to the HD 504 under the control of the CPU 501. The display 506 displays various information such as a cursor, a menu, a window, a character, or an image. The external device connection I/F 508 is an interface for connecting the computer 500 to various external devices. In this case, the external devices include, but not limited to, a universal serial bus (USB) memory and a printer. The network I/F 509 is an interface for performing data communication using the network N2. The bus line 510 is, for example, an address bus or a data bus, which electrically connects the components illustrated in FIG. 5, such as the CPU 501.

The keyboard 511 is an input device (input means) including multiple keys used to input characters, numerals, or various instructions, for example. The pointing device 512 is an example of an input device that allows a user to select or execute various instructions, select an item to be processed, or move a cursor being displayed. The DVD-RW drive 514 controls reading or writing of various data with respect to a DVD-RW 513, which is an example of a removable storage medium. The DVD-RW is merely one example of the removable storage medium. In another example, the DVD-RW drive 514 controls reading or writing of data with respect to a digital versatile disk recordable (DVD-R). The medium I/F 516 controls the reading or writing (storing) of data from or to a recording medium 515 such as a flash memory.

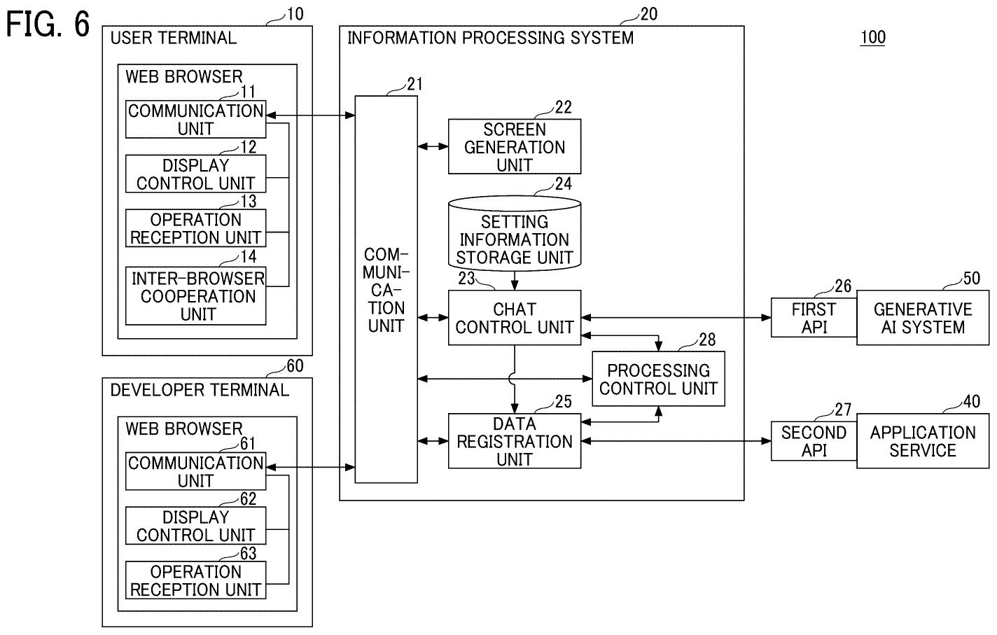

A description is given below of a functional configuration of the data registration system 100 with reference to FIG. 6. FIG. 6 is a diagram illustrating the functional configuration of the information processing system 20, the user terminal 10, and the developer terminal 60.

The user terminal 10 includes a communication unit 11, a display control unit 12, an operation reception unit 13, and an inter-browser cooperation unit 14. These functional units are functions or means that are implemented as the CPU 501 illustrated in FIG. 5 executes instructions included in one or more programs installed on the user terminal 10. For example, the communication unit 11, the display control unit 12, the operation reception unit 13, and the inter-browser cooperation unit 14 are implemented by one of or both of a web browser and a JavaScript® program. When the developer terminal 60 executes a native application, the communication unit 11, the display control unit 12, the operation reception unit 13, and the inter-browser communication unit 14 may be implemented by the native application.

The communication unit 11 transmits and receives various kinds of information to and from the information processing system 20. In the present embodiment, the communication unit 11 receives screen information of a daily report application screen from the application service 40, and receives screen information of a chat screen on which a chat message is input from the information processing system 20. The communication unit 11 transmits a chat message and operation information on the user terminal 10 to the information processing system 20. The communication unit 11 may directly communicate with the generative AI system 50.

The display control unit 12 interprets screen information of various screens to display screens on the display 506. The operation reception unit 13 receives various operations of the user on the various screens displayed on the display 506.

The inter-browser cooperation unit 14 transmits and receives information between the web browsers. One user terminal 10 can simultaneously execute multiple web browsers. The inter-browser cooperation unit 14 can notify information from one of the multiple web browsers to the other web browser (and vice versa). When only one of the web browsers includes authentication information for a specific web site (e.g., the application service 40), the inter-browser cooperation unit 14 enables the other web browser to communicate with the specific web site in cooperation with the one web browser. It is assumed that one of the web browsers communicates with the application service 40 and the other web browser communicates with the generative AI system 50 via the information processing system 20. The other web browser can transmit the response message from the generative AI system 50 to the one web browser. The function of the inter-browser cooperation unit 14 is executed by the web browser (user terminal 10), and is written in JavaScript® to implement the inter-browser cooperation unit 14 in the screen information transmitted from the application service 40 and the information processing system 20.

The developer terminal 60 includes a communication unit 61, a display control unit 62, and an operation reception unit 63. These functional units are functions or means implemented by the CPU 501 illustrated in FIG. 5 executing commands included in one or more programs installed in the developer terminal 60. For example, the communication unit 61, the display control unit 62, and the operation reception unit 63 may be implemented by at least one of the web browsers and the JavaScript® programs. Alternatively, the communication unit 61, the display control unit 62, and the operation reception unit 63 may be implemented by the native application when the developer terminal 60 executes a native application.

The communication unit 61 transmits and receives various kinds of information to and from the information processing system 20. In the present embodiment, the communication unit 61 receives screen information regarding input of setting information from the information processing system 20. The communication unit 61 transmits the setting information and operation information for the developer terminal 60 to the information processing system 20. The communication unit 21 can also communicate with the generative AI system 50 and the application service 40.

The display control unit 62 interprets screen information of various screens to display screens on the display 506. The operation reception unit 63 receives various operations of the user on the various screens displayed on the display 506.

The information processing system 20 includes a communication unit 21, a screen generation unit 22, a chat control unit 23, a setting information storage unit 24, a data registration unit 25, and a processing control unit 28. The functional units of the information processing system 20 are functions or means implemented by the CPU 501 illustrated in FIG. 5 executing commands included in one or more programs installed in the information processing system 20. The setting information storage unit 24 is implemented in the HD 504 or the RAM 503 illustrated in FIG. 5. The setting information storage unit 24 may not be included in the information processing system 20, and may be provided on a network that can be accessed by the information processing system 20.

The communication unit 21 transmits and receives various kinds of information to and from the user terminal 10. The communication unit 21 transmits screen information of the daily report application or the chat screen to the user terminal 10. The communication unit 21 receives chat messages input by the user from the user terminal 10. The communication unit 21 transmits and receives various kinds of information to and from the developer terminal 60. The communication unit 11 transmits screen information of an input screen of setting information to the developer terminal 60. The communication unit 11 receives the setting information input by the developer from the developer terminal 60 and stores the setting information in the setting information storage unit 24.

The screen generation unit 22 generates screen information of a screen (web page) displayed by the user terminal 10 and the developer terminal 60. The web page is provided as a part of the web application. The screen information is a program written in, for example, hypertext markup language (HTML), JavaScript® object notation (JSON), extensible markup language (XML), a script language, and a cascading style sheet (CSS). The structure of the web page is specified by HTML, the operation of the web page is defined by the script language, and the style of the web page is specified by the CSS. The user terminal 10 may execute a native application. The native application is an application that cannot be executed unless the application is installed in the user terminal 10. In the case of the native application, the user terminal 10 includes the screen information, and the information to be displayed is transmitted in JSON or XML.

The chat control unit 23 calls a first API 26 to transmit a request message to the generative AI system 50. The request message includes item names of the application and function specification settings. When the chat control unit 23 receives a chat message transmitted from the user terminal 10, the chat control unit 23 includes the received chat message in a request message and transmits the request message to the generative AI system 50. The chat control unit 23 may transmit a request message including a history of past conversations to the generative AI system 50 before and after the chat message is transmitted or together with the chat message. The first API 26 is one or more APIs published by the generative AI system 50. As a result of calling the first API 26, the chat control unit 23 receives a response message to the request message from the generative AI system 50. The response message includes a reply message to the chat message, a function call request to the information processing system 20, or dummy data.

The data registration unit 25 calls a second API 27 to transmit a request message to the application service 40. The data registration unit 25 functions by executing a predefined function. The request message includes parameters such as item names of the application and a data format) related to the application. The request message to the application service 40 is for requesting registration of dummy data.

The second API 27 is one or more APIs published by the application service 40. As a result of calling the second API 27, the data registration unit 25 receives a response message to the request message from the application service 40. The response message includes a result (success or failure) of the request for the registration of the dummy data. When the result is successful, the dummy data is successfully registered in the application.

The data registration unit 25 may generate dummy data in the information processing system 20 without requesting the application service 40. The data registration unit 25 may register, for example, dummy data managed by spreadsheet software in the spreadsheet software or may register dummy data in database software.

Generating or registering dummy data by the data registration unit 25 includes not only that the data registration unit 25 actually generates or registers dummy data, but also the data registration unit 25 requests the application service 40 to register the dummy data and the application service 40 actually registers the dummy data.

The processing control unit 28 determines a process to be performed next based on the chat message transmitted from the user terminal 10 and the button (content of operation) pressed by the user. The processing control unit 28 determines the process to request the chat control unit 23 or the data registration unit 25 to perform the processing.

In the present embodiment, the information processing system 20 calls the first API 26 published by the generative AI system 50 to use the generative AI system 50. The information processing system 20 can call the first API 26 to have a conversation with the AI which is one of the functions of the generative AI system 50. The generative AI system 50 has characteristic operations or processes, and thus, a supplementary description is given below.

The information processing system 20 transmits a request message for calling the API to the generative AI system 50 to communicate with the generative AI system 50. The information processing system 20 can acquire the response message from the generative AI system 50 using the request message enables.

The generative AI system 50 returns a response message to the request message to the information processing system 20. The reply message included in the response message of the generative AI system 50 is often different even if the chat message input by the user is the same. However, when the information processing system 20 designates a parameter called temperature as zero, the generative AI system 50 returns the same reply message in response to the same chat message.

When the information processing system 20 wants to continue the conversation with the generative AI system 50, each history of past conversations is included in the request message. This is because the conversation with the generative AI system 50 is stateless. This is a specification of one generative AI system 50, and another generative AI system 50 may not include a history of past conversations.

As described above, the first API 26 does not have any state regarding past communications (stateless). Accordingly, the user of the first API 26 (in the present embodiment, the information processing system 20 is the user) needs to include the history of past conversations and specifies the history of past conversations each time when the first API 26 is called. The history of past conversations may be included by the user terminal 10. When the history of past conversations is too long, the first API 26 returns an error. Accordingly, it is preferable that the information processing system 20 appropriately contrive the way to include the history of past conversations. For example, the information processing system 20 includes only the latest conversation in the request message when the conversations continue for a long time.

The functions provided by the generative AI system 50 include the function called function call. The function call indicates that the generative AI system 50 requests the information processing system 20 to call a function. Accordingly, when the information processing system 20 causes the generative AI system 50 to use this function, the generative AI system 50 can call the “function”.

The request message includes function specification setting set by the information processing system 20 so that the generative AI system 50 calls the “function”. The function specification setting enables the generative AI system 50 to perform a function call (function call request). As described above, the function specification setting is information on the first API 26 for calling the data registration unit 25. In other words, in the function specification setting, the information processing system 20 notifies the generative AI system 50 that the generative AI system 50 can request the information processing system 20 to call a function.

In this way, the information processing system 20 causes the generative AI system 50 to use the function call, and thus the generative AI system 50 calls the function provided by the information processing system 20, and the information processing system 20 can execute the function. The information processing system 20 can use the execution result of the function to have a conversation with the user.

However, since the response message of the generative AI system 50 is different each time, the generative AI system 50 may not make a function call request. Even if the information processing system 20 includes the function specification setting in the request message, the generative AI system 50 may return the same response message as that in the case where the function specification setting is not included.

A description is given below of continuity of the conversation between the user and the generative AI system 50. However, in the present embodiment, there is no phase in which the continuity of the conversation is preferable. When the process of including each history of past conversations in the request message is employed, it is necessary to include the execution result of the function executed by the information processing system 20 in the request message and transmit the request message to the generative AI system 50. However, the information processing system 20 may not include the execution result of the function in the request message and transmit the request message to the generative AI system 50 together with the history of past conversations. In other words, the information processing system 20 may transmit the execution result of the function to the user terminal 10 as it is. However, when the information processing system 20 transmits the execution result of the function to the generative AI system 50, the generative AI system 50 can continue the conversation using the history of past conversations, and thus, continuity is created in the conversation. For example, consistency is generated in the style of writing and wording, and thus the user is less likely to feel any sense of discomfort. For example, even if the user's native language is English and the user has a conversation in English, the information processing system 20 does not need to translate the reply message into English.

The information processing system 20 cannot predict whether the generative AI system 50 will request a function call. However, when the information processing system 20 explicitly designates the function call in the request message, the information processing system 20 can force the generative AI system 50 to call the function.

In the present embodiment, a description is given below of a request message transmitted by the information processing system 20 and a response message transmitted by the generative AI system 50 in a case where the user registers dummy data in the daily report application.

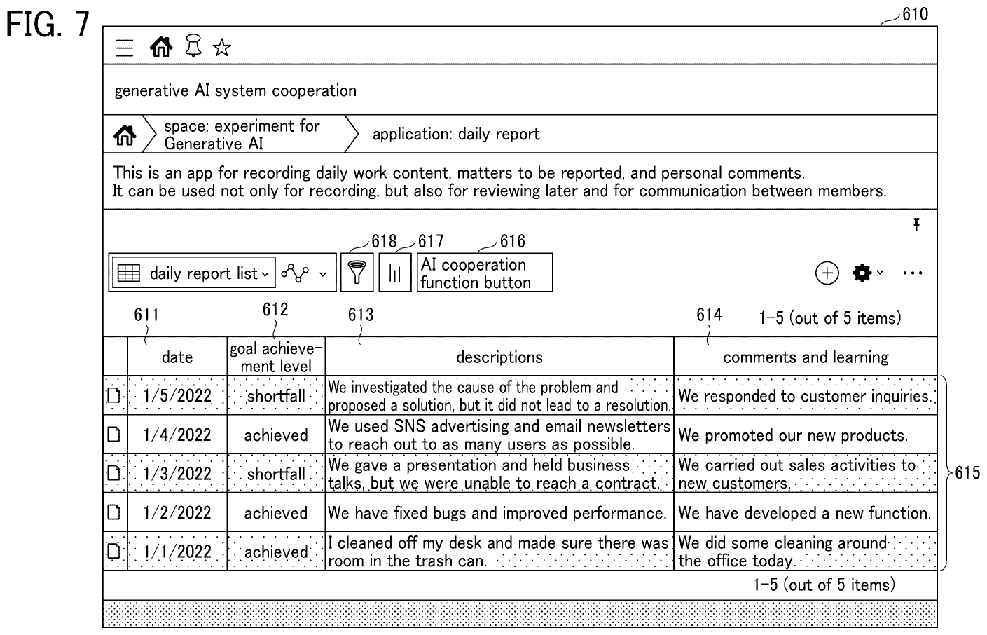

For convenience of description, a description is given below of screens displayed by the user terminal 10 when the user generates dummy data with reference to FIGS. 7 to 11. The request message and the response message are described after the screens displayed by the user terminal 10 when the user generates dummy data.

FIG. 7 is a diagram illustrating a daily report application screen 610 displayed by the user terminal 10. The daily report application is a web application executed by the application service 40. The daily report application includes items of date 611, goal achievement level 612, descriptions 613, and comments and learning 614. Five records 615 have been input into a table illustrated in FIG. 7. The five records 615 may be dummy data or may be data manually input by the user.

The generative AI system 50 has a variety of ways to support the user with no-code or low-code for an application. The AI cooperating function button 616 is used to display such various ways of support. A filtering button 618 is used to filter each record based on a predetermined condition, and a calculation button 617 is used to calculate statistical information of each record and graph the statistical information.

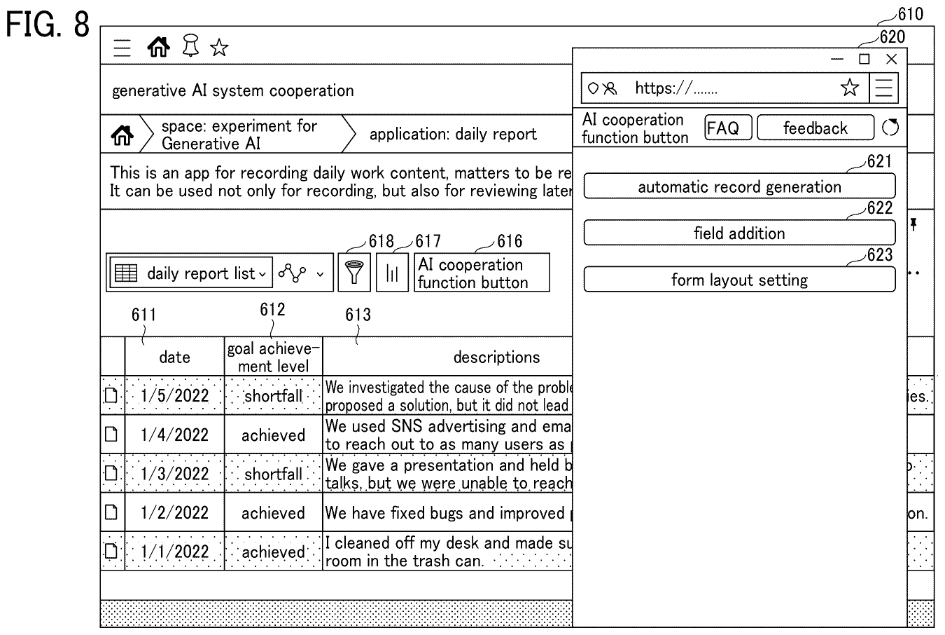

FIG. 8 is a diagram illustrating a function selection screen 620 displayed when the user presses the AI cooperating function button 616. When the AI cooperating function button 616 is pressed on the daily report application screen 610, the application ID of the daily report application is identified. The function selection screen 620 is displayed in a pop-up manner so that the function selection screen 620 overlaps the daily report application screen 610. The function selection screen 620 may be displayed after the screen transition from the daily report application screen 610. The function selection screen 620 includes an automatic record generation button 621, a field addition button 622, and a form layout setting button 623.

The automatic record generation button 621 is used to automatically generate and register dummy data. The field addition button 622 is used by the user to add an item (field) to the daily report application with the support of the generative AI system 50. The form layout setting button 623 is used by the user to change the arrangement of the items of the daily report application with the support of the generative AI system 50. The arrangement of the items of the daily report application is the position of each item on the input screen (a screen different from FIG. 7) of the daily report application.

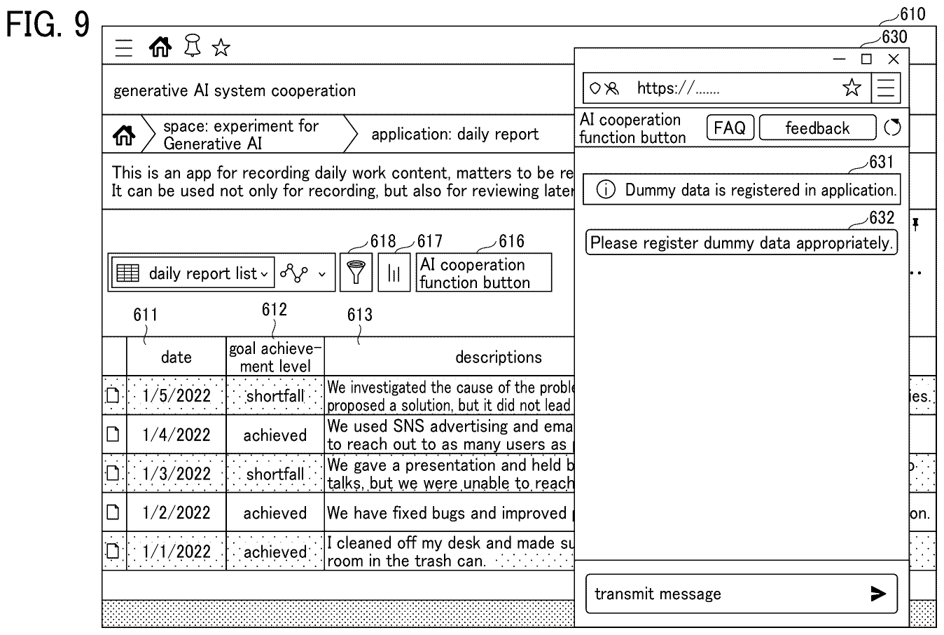

FIG. 9 is a diagram illustrating a chat screen 630 displayed when the user presses the automatic record generation button 621. The chat screen 630 is displayed in a pop-up manner so that the chat screen 630 overlaps the daily report application screen 610. The chat screen 630 may be displayed after the screen transition from the daily report application screen 610. The chat screen 630 includes a message 631 “Dummy data is registered in application.” The user sees the message 631 and inputs a chat message 632 that contains “Please register dummy data appropriately.”

When the user terminal 10 transmits the chat message 632 to the information processing system 20, the information processing system 20 acquires information (item name) of the daily report application from the application service 40. The information processing system 20 designates information of the daily report application to request the generative AI system 50 to generate dummy data, and acquires the dummy data from the generative AI system 50. At this point, the information processing system 20 can also register the dummy data in the application service 40. However, when multiple pieces of data that have been input to the daily report application suddenly increase or when multiple pieces of data that the user does not like increase, the user may be confused. Then, the information processing system 20 registers the dummy data in the application after the user's permission. The information processing system 20 transmits a message to the user terminal 10 for confirming whether to register the dummy data.

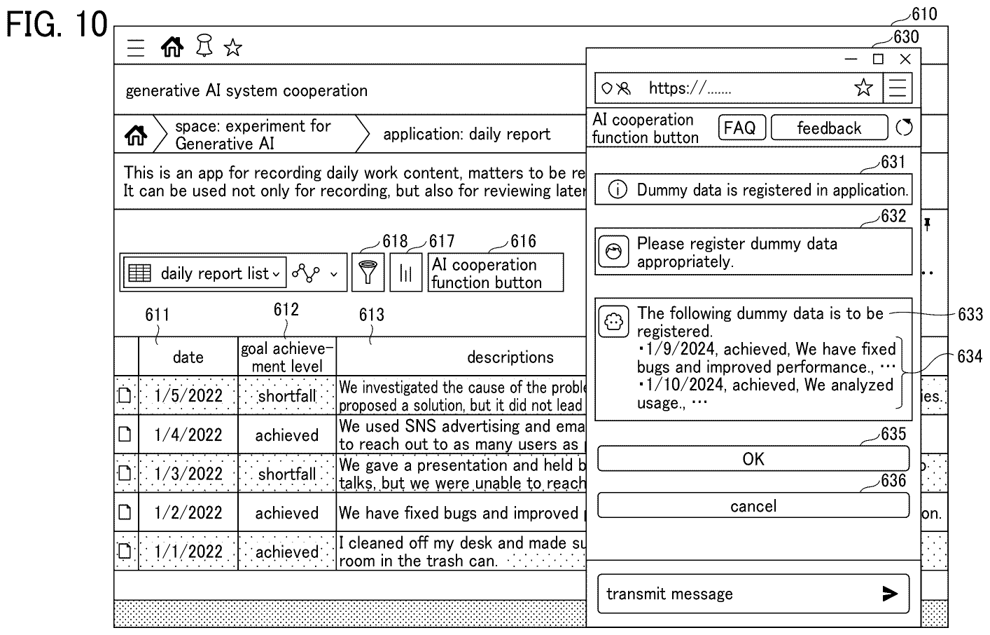

FIG. 10 is a diagram illustrating the chat screen 630 on which the generated dummy data is displayed. On the chat screen 630 of FIG. 10, a message 633 that contains “The following dummy data is to be registered.” and two pieces of dummy data 634 are displayed. The message 633 corresponds to a request for confirmation of the registration of the data in the application service 40. The chat screen 630 includes an OK button 635 and a cancel button 636. When the user presses the OK button 635, the information processing system 20 registers the dummy data 634 in the daily report application of the application service 40. Pressing the OK button 635 corresponds to receiving an instruction to register dummy data included in the request (function_call) from the generative AI system 50.

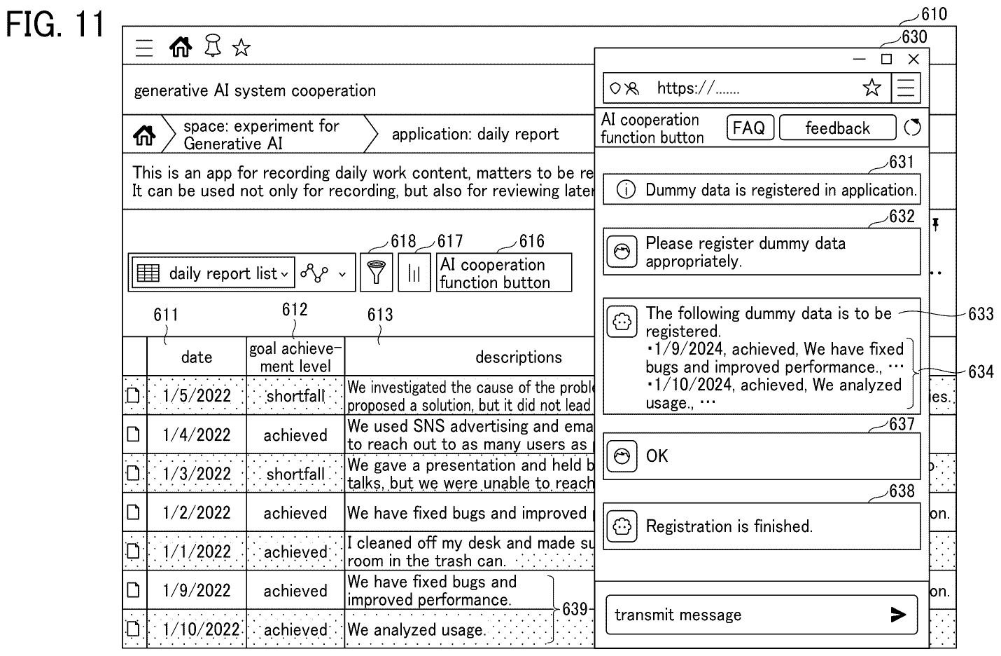

FIG. 11 is a diagram illustrating the daily report application screen 610 and the chat screen 630 displayed when the user presses the OK button 635. In the chat screen 630 of FIG. 11, a chat message 637 including “OK” input by the user pressing the OK button 635 and a response message 638 of “Registration is finished” are displayed. Two pieces of dummy data 639 are registered in the daily report application. The dummy data 639 is, for example, dates and character strings, and is the same as the dummy data 634 in FIG. 10.

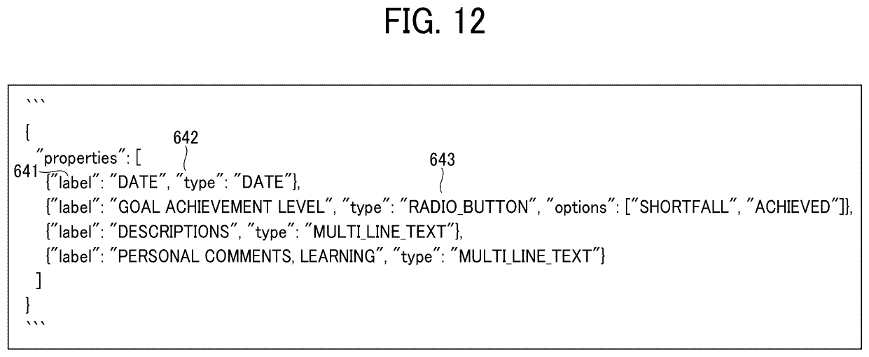

A description is given below of a request message transmitted from the information processing system 20 to the application service 40 or the generative AI system 50 and a response message received by the information processing system 20 from the application service 40 or the generative AI system 50 with reference to FIG. 12.

FIG. 12 is a diagram illustrating a response message acquired from the application service 40 by the information processing system 20. When the user inputs the chat message 632 that contains “Please register dummy data appropriately.” on the chat screen 630, the data registration unit 25 transmits a request message for calling the second API 27 to the application service 40. The request message includes a request for the application ID and the application information (such as an item name and a data format). As a result, the data registration unit 25 acquires the response message illustrated in FIG. 12.

In the response message of FIG. 12, a label 641 indicates the item name, and a type 642 indicates the format. The label of “goal achievement level” also includes options 643. The options 643 are the names of buttons displayed on the buttons when the data format is “RADIO BUTTON.” As described above, the data registration unit 25 can acquire the application information (such as the item name and the data format) of the application from the application service 40.

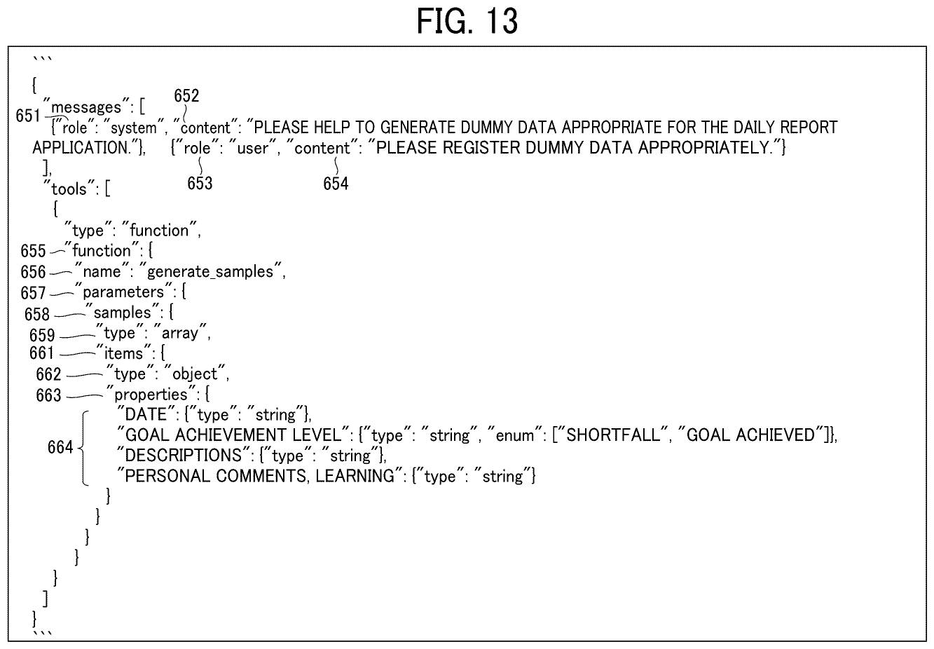

Then, the chat control unit 23 generates a request message for requesting the generative AI system 50 to generate dummy data, using the response message of FIG. 12. FIG. 13 is a diagram illustrating a request message for calling the first API 26 published by the generative AI system 50. The request message includes role 651, role 653, content 652, and content 654. The role 651 and the role 653 indicate speakers, and the speaker can be a user, an assistant (AI of the generative AI system 50), and a system (instructing setting of AI assistant). The content 652 and the content 654 are the content of the conversation and may be described in a natural language. The content 652 of the system is “Please help to generate dummy data appropriate for the daily report application.” The content 652 is generated by the chat control unit 23 in response to the pressing of the automatic record generation button 621 of FIG. 8. However, when the user inputs a chat message indicating that the user wants to generate dummy data, the content 652 may not be generated.

The content 654 of the user is “Please register dummy data appropriately.” The content 654 is the chat message 632 input by the user on the chat screen 630 of FIG. 9. The request message of FIG. 13 includes a function specification setting 655. A “function” illustrated in FIG. 13 is the function specification setting 655, and the function specification setting 655 includes the following attributes. Name 656 illustrated in FIG. 13 is the name of the function (the name of the function is generate_samples). Parameters 657 illustrated in FIG. 13 are also part of the function specification and specify the type of item. Samples 658 illustrated in FIG. 13 are also part of the function specification, and indicate that a sample of the item name is included. ““Type”: “array”” 659 illustrated in FIG. 13 indicates that the item is in a table format. “iItems” 661 and the following items illustrated in FIG. 6 indicate item names and data formats. ““Type”: “object”” 662 illustrated in FIG. 13 indicates the data format of the return value of the function. “Properties” 663 illustrated in FIG. 13 include item information 664 of the application returned to the information processing system 20 by the application service 40 using the response message. The item information 664 includes an item name and a data format of each item. The item information 664 may include a button name (“shortfall” or “achieved” of FIG. 13) corresponding to the option 643 of FIG. 12.

The information processing system 20 instructs the generative AI system 50 that the generative AI system 50 can request the information processing system 20 to call the function defined as illustrated in FIG. 13 using the function specification setting 655.

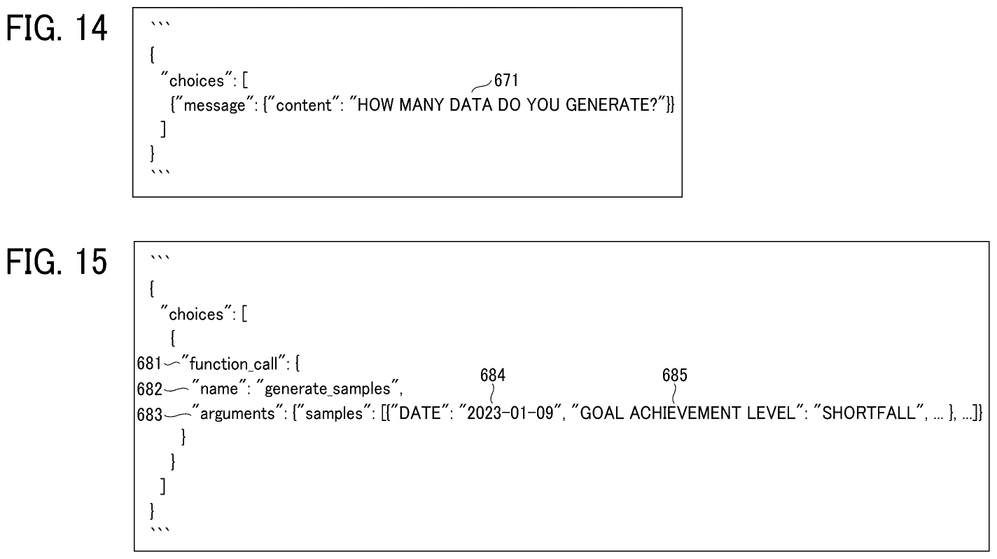

FIG. 14 is a diagram illustrating a response message transmitted from the generative AI system 50 to the information processing system 20 in response to the request message of FIG. 13. Since the response message of FIG. 14 does not include a function call request (function call), the response message is not a response message expected by the chat control unit 23. In such a case, the information processing system 20 transmits a response message 671 included in the response message to the user terminal 10. Since the response message 671 is “How many data do you generate?”, the user inputs an appropriate number of data to the user terminal 10 and the user terminal 10 transmits the appropriate number of data to the information processing system 20. The chat control unit 23 transmits the request message including the number of data to the generative AI system 50, and thus the chat control unit 23 can acquire the response message including the function call request (function call).

FIG. 15 is another diagram illustrating a response message transmitted from the generative AI system 50 to the information processing system 20 in response to the request message of FIG. 13. The response message includes a function call request 681 (function call). In the present embodiment, when the function call of FIG. 15 is included in the response message, the chat control unit 23 detects the function call, and the data registration unit 25 requests the application service 40 to register dummy data. The application service 40 is a no-code platform or low-code platform. In the present embodiment, the information processing system 20 calls the second API 27 published by the application service 40 and the first API 26 published by the generative AI system 50, and thus, the information processing system 20 can register the dummy data in the application of the application service 40 while the user is having a conversation with the generative AI system 50 in a natural language.

The function call request 681 of the response message corresponds to a registration request of the dummy data. The function call request 681 includes name 682 and arguments 683. The name 682 illustrated in FIG. 7 is the name of the function defined in the function specification setting 655 of FIG. 6. The generative AI system 50 requests a call to a function with this name to the information processing system 20. The arguments 683 are return values, and are defined in the function specification setting 665. In the arguments 683 of FIG. 15, dummy data 684 (item value) that contains “2023 Jan. 9” is generated for the item name “date”, and dummy data 685 (item value) that contains “shortfall” is generated for the item name “goal achievement level.” In this way, the generative AI system 50 generates dummy data for each item and transmits the dummy data to the information processing system 20.

The generative AI system 50 can specify the item name of the daily report application and the dummy data by the function call request 681 and thus, the generative AI system 50 requests the information processing system 20 to call a function for registering the generated dummy data.

The chat control unit 23 of the information processing system 20 analyzes the function call request 681 included in the response message of FIG. 15, and determines whether to register the dummy data in the application service 40 (execution of the function). The chat control unit 23 notifies the data registration unit 25 that the function call request 681 has been received. The data registration unit 25 calls the second API 27 published by the application service 40 and uses the item name and the information format (an example of the parameter) included in the response message to request the application service 40 to register the dummy data.

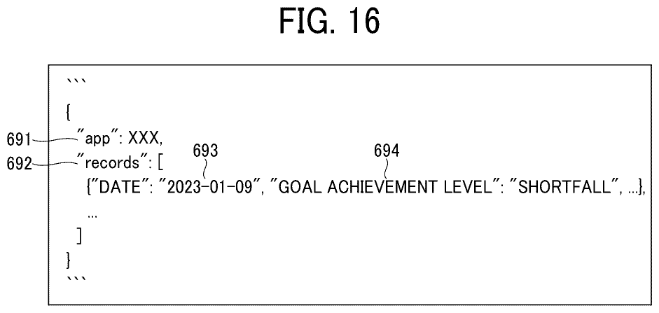

Specifically, the information processing system 20 uses an API of the application service 40 as described below. An API for registering dummy data published by the application service 40 illustrated in FIG. 16 is an example of a request message transmitted to the application service 40 by the data registration unit 25 based on the function call request 681 of FIG. 15. The data registration unit 25 calls the second API 27 to transmit the request message of FIG. 16 to the application service 40. The application ID of the daily report application (an example of application identification information for identifying application) is stored in “XXX” of app 691 of FIG. 16. Records 692 of FIG. 16 are content of a record (dummy data) to be registered, and value 694 of FIG. 16 is associated with item name 693 of FIG. 16.

By the request message and the response message described above, the dummy data is registered in the daily report application of the application service 40 in association with the item name and the value.

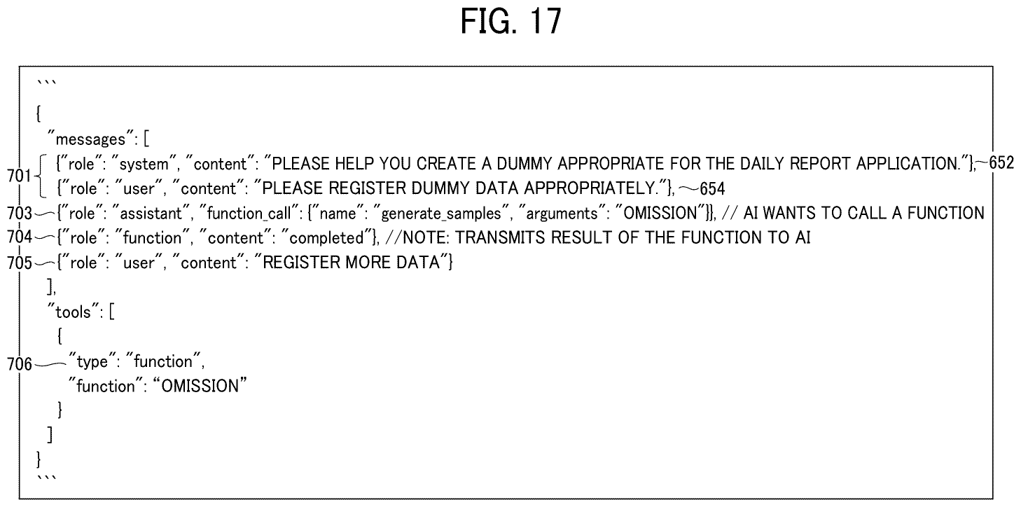

A description is given below of a case where the user inputs a chat message indicating that the user wants to further register dummy data. The chat control unit 23 calls the first API 26 with a request message as illustrated in FIG. 17 in response to the chat message from the user.

FIG. 17 is a diagram illustrating the request message for calling the first API 26 published by the generative AI system 50. The request message includes the contents 652 and 654 illustrated in FIG. 13 as a conversation history 701. Description 703 is also a history of past conversations, indicating that the generative AI system 50 has already requested a function call. Description 704 notifies the generative AI system 50 of the execution result of the function. In other words, when the user inputs a chat message to further register dummy data, the chat control unit 23 includes the execution result (completed or failed) of the function in the response message. Description 705 is a chat message input by the user. In this case, the user has input a chat message “Register more data.” Although description 706 and the following descriptions are omitted, the function specification setting is described as in FIG. 13.

The chat control unit 23 repeats generating a request message including a past history, calling the first API 26 of the generative AI system 50, and receiving a response message as illustrated in FIG. 17. As a result, the chat control unit 23 can interact with the generative AI system 50 to register dummy data in the application service 40. The user can only input a chat message to register dummy data in an any application.

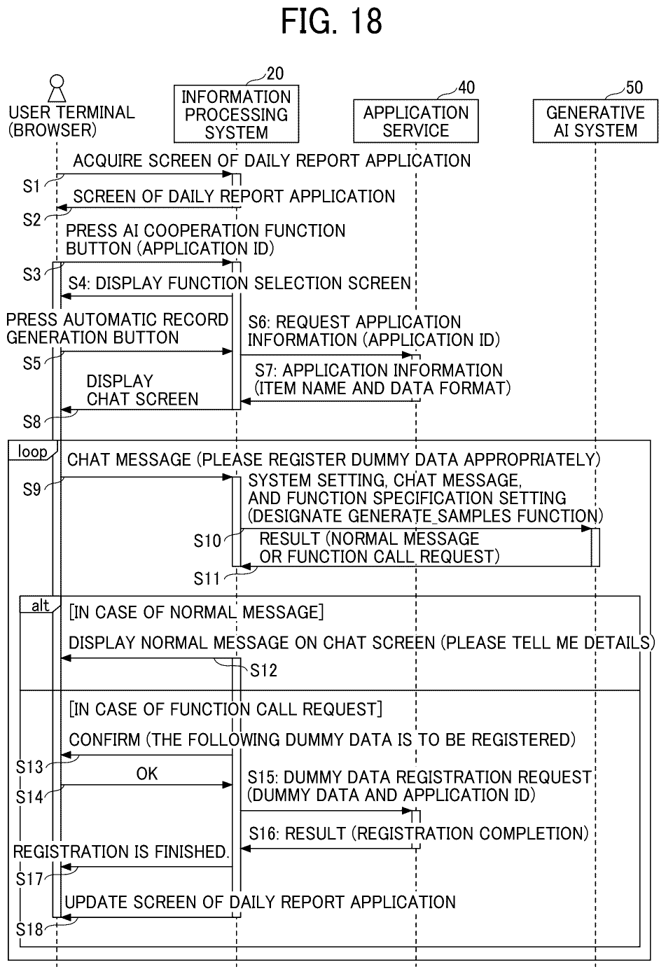

FIG. 18 is a sequence diagram illustrating processing in which the information processing system 20 supports registration of dummy data. As a large processing flow, steps S9 to S18 are repeatedly executed, and within the steps S9 to S18, the process branches to step S12 or S13.

In step S1, the communication unit 11 of the user terminal 10 connects to the uniform resource locator (URL) of the information processing system 20. The URL may be designated by a method in which the user directly inputs the URL in the user terminal 10 or by executing a shortcut in which the URL is designated. The communication unit 11 of the user terminal 10 generates an HTTP request including the URL of the daily report application and transmits the generated HTTP request to the information processing system 20.

In step S2, when the communication unit 21 of the information processing system 20 receives the HTTP request from the user terminal 10, the screen generation unit 22 creates screen information of the daily report application. The communication unit 21 transmits an HTTP response including screen information of the daily report application to the user terminal 10 as a response to the HTTP request (see FIG. 7).

In step S3, the user operates the user terminal 10 to press the AI cooperating function button 616. The operation reception unit 13 receives pressing of the button. Thus, the application ID is identified. The communication unit 11 of the user terminal 10 transmits the notification indicating that the AI cooperating function button 616 has been pressed and the application ID to the information processing system 20.

In step S4, in response to the communication unit 21 of the information processing system 20 receiving the notification indicating that the AI cooperating function button 616 has been pressed and the application ID, the screen generation unit 22 generates a function selection screen. The communication unit 21 transmits the screen information of the function selection screen to the user terminal 10.

In step S5, when the communication unit 11 of the user terminal 10 receives the screen information of the function selection screen, the display control unit 12 displays the function selection screen 620 (see FIG. 8). The user operates the user terminal 10 to press the automatic record generation button 621. The operation reception unit 13 receives pressing of the automatic record generation button 621. The communication unit 11 of the user terminal 10 transmits the notification indicating that the automatic record generation button 621 is pressed to the information processing system 20.

In step S6, the communication unit 21 of the information processing system 20 receives the notification indicating that the automatic record generation button 621 is pressed, and the processing control unit 28 causes the data registration unit 25 to acquire the application information in response to the automatic record generation button 621 being pressed. The data registration unit 25 calls the second API 27. The data registration unit 25 uses the request message for requesting acquisition of the application information together with the application ID to call the second API 27.

In step S7, the application service 40 returns the application information (such as item name and data format) of the application identified by the application ID to the information processing system 20 via the second API 27 (see FIG. 12). The data registration unit 25 acquires the application information (such as item name and data format) from the application service 40.

In step S8, since the application information has been acquired, the screen generation unit 22 of the information processing system 20 transmits the screen information of the chat screen to the user terminal 10. Accordingly, the user can instruct the generation of dummy data on the chat screen.

In step S9, when the communication unit 11 of the user terminal 10 receives the screen information of the chat screen, the display control unit 12 displays the chat screen (see FIG. 9). The user operates the user terminal 10 to input a chat message. The chat message 632 is, for example, “Please register dummy data appropriately.” The operation reception unit 13 receives input. The communication unit 11 of the user terminal 10 generates a request message including the chat message and transmits the generated request message to the information processing system 20. The communication unit 11 of the user terminal 10 transmits the generated request message as, for example, an HTTP request. The communication unit 11 of the user terminal 10 may generate the request message including a history of past conversations. The information processing system 20 may store the history of past conversations. When the information processing system 20 stores the history of past conversations, the communication unit 11 of the user terminal 10 may not include the history of the past conversations in the request message.

In step S10, the communication unit 21 of the information processing system 20 receives the request message. The processing control unit 28 of the information processing system 20 determines whether to register dummy data based on the automatic record generation button 621 being pressed or the processing control unit 28 analyzes the chat message 632 to determine whether to register dummy data. The generative AI system 50 may be used to analyze the chat message 632. In this case, the chat control unit 23 of the information processing system 20 transmits the chat message 632 to the generative AI system 50 and acquires a request or intention of the user to register dummy data.

The processing control unit 28 passes the chat message to the chat control unit 23. The chat control unit 23 generates a request message including the system setting (setting information), the chat message, and the function specification setting, and the chat control unit 23 calls the API 26 to transmit the generated request message to the generative AI system 50 (see FIG. 13).

In step S11, the generative AI system 50 returns a reply message (normal message) or a response message including a function call request to the information processing system 20 (see FIGS. 14 and 15). The chat control unit 23 receives the response message from the generative AI system 50. The response message that the chat control unit 23 receives may be a reply message (FIG. 14) or a function call request (FIG. 15). When the response message is the reply message, the process proceeds to step S12, and when the response message is the function call request, the process proceeds to step S13.

In step S12, when the chat control unit 23 receives the normal reply message, the communication unit 21 of the information processing system 20 transmits the reply message to the user terminal 10. For example, the reply message is “Please tell me details.”

In step S13, when the chat control unit 23 receives the function call request, the chat control unit 23 analyzes the function and determines that registration of dummy data in the application service 40 is requested. Since the function for registering dummy data is designated in the function specification setting in step S10, the chat control unit 23 can easily determine that the request is the registration request of the dummy data based on the name (name 682) of the function included in the function call request. The chat control unit 23 also acquires the arguments 683 (such as item name and data format) included in the function call request.

In order to receive the user's confirmation, the chat control unit 23 causes the screen generation unit 22 to generate a confirmation message (e.g., “The following dummy data is to be registered.”). The communication unit 21 transmits the confirmation message to the user terminal 10.

In step S14, when the communication unit 11 of the user terminal 10 receives the confirmation message, the display control unit 12 displays the chat screen (see FIG. 10). The chat screen 630 displays a message 633 that contains “The following dummy data is to be registered”, the two dummy data 634, the OK button 635, and the cancel button 636. The user operates the user terminal 10 to press the OK button 635 or the cancel button 636. In this case, the OK button 635 is to be pressed. The operation reception unit 13 receives pressing of the button. The communication unit 11 of the user terminal 10 transmits the notification indicating that the OK button 635 has been pressed to the information processing system 20.

In step S15, the communication unit 21 of the information processing system 20 receives the notification indicating that the OK button 635 has been pressed. Since the OK button 635 has been pressed, the processing control unit 28 of the information processing system 20 determines to register the dummy data in the data registration unit 25. The data registration unit 25 calls the second API 27 to transmit a request message for registering the dummy to the application service 40 (see FIG. 16). In other words, the data registration unit 25 transmits the request message to implement the function of the function call request from the generative AI system 50. In the present embodiment, the data registration unit 25 registers the dummy data. The data registration unit 25 calls the one or more APIs described above. The data registration unit 25 includes the application ID and the arguments 683 (item names and values) in a request message, which are parameters included in the response message from the generative AI system 50, and requests the registration of the dummy data. The request message may vary depending on the application service 40.

As described above, the generative AI system 50 transmits a request (function_call) based on the chat message, and the item name, and the function specification setting. The request includes the dummy data generated based on the chat message and the item name. When the chat control unit 23 receives the request, the data registration unit 25 can register the dummy data included in the received request in the target application.

In step S16, the data registration unit 25 receives a response message from the application service 40. The result included in the response message is, for example, the completion of registration. The result included in the response message also may include registered dummy data. The registration of dummy data rarely fails. However, when the registration fails, a message indicating the failure is transmitted to the user terminal 10. The process returns to, for example, step S9.

In step S17, when the registration of dummy data is successful, the communication unit 21 of the information processing system 20 transmits, for example, a message that is “Registration is finished” to the user terminal 10 (see FIG. 11).

In step S18, the communication unit 21 may request the user terminal 10 to update the daily report application screen 610. When the daily report application screen 610 has been updated, the dummy information registered in step S15 is displayed on the daily report application screen 610 displayed on the user terminal 10 (see FIG. 11). As an update method, a method in which the information processing system 20 causes the user terminal 10 to execute an update process or a method in which the user terminal 10 receives a notification of registration from the application service 40 and acquires dummy data is performed. The user may manually display the update result.

The process of FIG. 18 is ended, and after that, the user returns to step S9 as needed to add more dummy data. In this case, the user can input a chat message for registering another dummy data.

In order for the information processing system 20 to call the second API 27, the information processing system 20 needs to be authenticated by the application service 40. When the information processing system 20 in the sequence diagram of FIG. 18 operates in the same domain as the application service 40, authentication information of the application service 40 is transmitted from the web browser operating in the user terminal 10 to the information processing system 20. The authentication information is included in, for example, a cookie in advance. Then, the information processing system 20 can call the second API 27 published by the application service 40. When a no-code platform or low-code platform (application service 40) and the information processing system 20 are developed by the same organization, it is considered to be easy for the application service 40 and the information processing system 20 to operate in the same domain, and in this case, it is considered that there is no problem.

However, when the information processing system 20 and the application service 40 operate in different domains, a problem related to authentication may occur. A description is given below with reference to FIG. 8. The user can use an application or develop an application from the daily report application screen 610.

For example, it is considered that the configuration of the daily report application screen 610 provided by the application service 40 is as follows. The daily report application screen 610 is opened by the web browser. When the user presses the AI cooperating function button 616 on the daily report application screen 610, the function selection screen 620 for communicating with the information processing system 20 is displayed in a pop-up manner. It is assumed that the function selection screen 620 is opened by another web browser. In this case, since the application service 40 and the information processing system 20 are in different domains, the user terminal 10 cannot transmit the authentication information of the application service 40 to the information processing system 20. Accordingly, the information processing system 20 cannot call the second API 27 published by the application service 40. The function selection screen 620 displayed in a pop-up manner operates in a domain different from that of the daily report application screen 610, and thus the function selection screen 620 (another web page) displayed in a pop-up manner cannot access the cookie of the application service 40.

A configuration is considered in which the function selection screen 620 (another web page) displayed in a pop-up manner requests the daily report application screen 610 to call the second API 27 published by the application service 40.

FIGS. 19 and 20 are sequence diagrams illustrating that the information processing system 20 utilizes the cooperation of two web browsers in the user terminal 10 to register dummy data to the application service 40. The description given in reference to FIGS. 19 and 20 may mainly include the differences from FIG. 18.

In step S21, the user designates the URL of the application service 40 to the user terminal 10. A web browser 240 (a first web browser) is a web browser that is connected to the application service 40.

In step S22, the communication unit 11 of the user terminal 10 connects to the URL of the application service 40. Since the user designates the URL of the daily report application screen 610 to the user terminal 10, the web browser 240 of the user terminal 10 transmits an HTTP request including the URL of the daily report application screen 610 to the application service 40.

In step S23, when the application service 40 receives the HTTP request from the user terminal 10, the application service 40 transmits (e.g., HTML-based, JavaScript®-based, or CSS-based) screen information of the daily report application screen 610 to the user terminal 10. The screen information includes a script for activating the other web browser 250 (a second web browser) and the URL of the function selection screen 620.

In step S24, the communication unit 11 of the user terminal 10 receives the screen information of the daily report application screen 610, and the display control unit 12 of the web browser 240 displays the daily report application screen 610 (see FIG. 7).

In step S25, the user presses the AI cooperating function button 616 on the daily report application screen 610.

In step S26, accordingly, the inter-browser cooperation unit 14 activates the web browser 250. The application ID of the daily report application screen 610 and the URL of the function selection screen 620 are notified to the web browser 250. The web browser 250 is displayed in a pop-up manner. More specifically, a JavaScript® program included in the screen information of the daily report application screen 610 activates the web browser 250.

In step S27, the web browser 250 uses the URL of the function selection screen 620 notified from the web browser 240 to request the function selection screen 620 to the information processing system 20.

In step S28, in response to the request, the screen generation unit 22 of the information processing system 20 generates (e.g., HTML-based, JavaScript®-based, or CSS-based) screen information of the function selection screen 620, and the communication unit 21 transmits the screen information of the function selection screen 620 to the web browser 250 (the user terminal 10).

In step S29, the communication unit 11 of the user terminal 10 receives the screen information of the function selection screen 620. The display control unit 12 displays the function selection screen 620 based on the screen information (see FIG. 8).

In step S30, the user operates the user terminal 10 to press the automatic record generation button 621 on the function selection screen 620. The operation reception unit 13 receives the pressing of the automatic record generation button 621.

In step S31, since the automatic record generation button 621 is pressed, the inter-browser cooperation unit 14 of the web browser 250 designates the application ID to request the web browser 240 to acquire the application information of the application services 40. As such communication (message communication) between browsers, the postMessage that is a method of the web API can be used.

In step S32, the web browser 240 generates a request message to call the second API 27 of the application services 40. The request message is a message for requesting the application service 40 to acquire application information with the application ID designated by the web browser 250.

In step S33, the application service 40 includes the application information (such as item name and data format) of the application identified by the application ID in the response message, and transmits the response message to the web browser 240.

In step S34, the inter-browser cooperation unit 14 of the web browser 240 transmits the application information to the web browser 250.

In step S35, when the web browser 250 receives the application information, the web browser 250 switches the display from the function selection screen 620 to the chat screen 630. The chat screen 630 is transmitted from the information processing system 20 in step S28. The web browser 250 displays the chat screen 630 (see FIG. 9).

In step S36, subsequently, the user inputs the chat message 632 such as “Please register dummy data appropriately.”

The subsequent processing in steps S37 to S40 is the same as the processing in steps S9 to S12 of FIG. 18.

In step S41, when the web browser 250 receives the response message (in this case, the reply message) from the generative AI system 50 in step S40, the display control unit 12 of the web browser 250 displays the reply message (e.g., “Please tell me details.”).

The subsequent processing in steps S42 and S43 may be the same as the processing in steps S13 and S14 in FIG. 18. The user terminal 10 displays the chat screen 630 of FIG. 10.

In step S44, when the OK button 635 is pressed on the chat screen 630 of FIG. 10, the inter-browser cooperation unit 14 of the web browser 250 designates the application ID to the application services 40 and requests the web browser 240 to register the dummy information. The cooperation between the browsers may be performed in the same manner as in step S31.

In step S45, the web browser 240 calls the second AP 127 to designate the application ID and register the dummy data in the application service 40.

In step S46, the application service 40 transmits the result of the registration of the dummy data to the web browser 240. The result of the registration of the dummy data is, for example, the completion of registration. The result included in the response message also may include registered dummy data. The registration of dummy data rarely fails. However, when the registration fails, a message indicating the failure is transmitted to the web browser 240. The process returns to, for example, step S36.

In step S47, the inter-browser cooperation unit 14 of the web browser 240 transmits the result of the registration of the dummy data to the web browser 250.

In step S48, when the registration is finished, the web browser 250 displays a message such as “Registration is finished” on the chat screen 630 (see FIG. 11).

The web browser 250 requests the web browser 240 to update the daily report application screen 610 and thus, the web browser 250 can display the daily report application screen 610 including the dummy data registered by the web browser 240. Alternatively, the web browser 240 receives a notification of registration from the application service 40 and acquires new dummy data.

In the information processing system 20 according to the present embodiment, the user only inputs a request for registering dummy data to the user terminal 10, and thus, the information processing system 20 can generate dummy data to be used in an application using the generative AI system 50 to register the dummy data in the application service 40. Although the existing generative AI system can also create dummy data, the user has to instruct the existing generative AI system of an item name. When the existing generative AI system returns dummy data, the user has to input the dummy data to the application service 40 one by one. In contrast, in the present embodiment, when the user inputs a request for registering dummy data in an application, the information processing system 20 can register the dummy data to be used by the application in the application.

The embodiments described above are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, in the present embodiment, the dummy data generated by the generative AI system 50 is text data, but may be a numerical value. The dummy data generated by the generative AI system 50 may be image data. The image data may be any of various types of data, such as an illustration for instruction, a map, a layout drawing of a desk, or an illustration of a web page. The image data may be a moving image. The dummy data may be a text or a table such as form data. The dummy data also may be a radio button, a check box, time, an attached file, or a link (URL).

In the present embodiment, dummy data of an application is generated, but the dummy data may be dummy data of a file generated by the application. For example, when the application is spreadsheet software, the information processing system 20 causes the generative AI system 50 to generate dummy data to be set in the item of spreadsheet software. Then, the information processing system 20 registers the generated dummy data in the spreadsheet software. As a use case, the user transmits a file for the spreadsheet software and a chat message to the information processing system 20. Since the information processing system 20 transmits the file for the spreadsheet software to the generative AI system 50 together with the function specification setting and the chat message, the generative AI system 50 returns the dummy data to the information processing system 20. The information processing system 20 registers dummy data in the file for the spreadsheet software.

The application itself may execute the functions of the information processing system 20 described in the present embodiment. In this case, since the application receives the application ID from the user terminal 10, the information processing system 20 does not need to transmit the application ID to the application service 40.

In the present embodiment, the information processing system 20 receives a function call request from the generative AI system 50. However, the information processing system 20 may receive a call request of the web-API directly from the generative AI system 50. In other words, the function and the API may not be strictly distinguished from each other.

The apparatuses or devices described in the embodiments described above are merely one example of multiple computing environments that implement the embodiments disclosed herein. In some embodiments, the information processing system 20 includes multiple computing devices, such as a server cluster. The multiple computing devices are configured to communicate with one another through any type of communication link including, for example, a network or a shared memory, and perform the processes disclosed in the present specification.

The information processing system 20 can be configured to share the disclosed processing steps, for example, the processes illustrated in FIG. 10, in various combinations. For example, a process performed by a given unit may be performed by multiple information processing apparatuses included in the information processing system 20. The elements of the information processing system 20 are combined into one server apparatus or are divided into multiple apparatuses.

The configuration illustrated in, for example, FIG. 6 is divided according to main functions in order to facilitate understanding of processing by the information processing system 20. The scope of the present disclosure is not limited by how the process units are divided or by the names of the process units. The processes implemented by the information processing system 20 can be divided to a larger number of processes depending on the contents of processes. One process may be divided to include the larger number of processes.

Embodiments of the present disclosure provide significant enhancements in computer capabilities and functionality. These enhancements allow users to utilize computers that provide more efficient and robust interaction with tables, which are a way to store and present information on information processing apparatuses. Embodiments of the present disclosures provide a better user experience through the use of a more efficient, powerful, and robust user interface. Such a user interface provides a better interaction between a human and a machine. A description is given below of some aspects of the present disclosure.

### Aspect 1

An information processing apparatus that can communicate with a terminal device and a generative AI system via a network includes a data registration unit and a chat control unit. The data registration unit functions by executing a predefined function and registers data to be used by an application in the application. The data registration unit registers the data included in a request in the application. When the chat control unit receives a chat message transmitted from the terminal device, the chat control unit transmits the received chat message to the generative AI system. The chat control unit transmits information on the application in which the data is to be registered and information for the generative AI system to call the function to the generative AI system at least once. When the chat control unit receives the request transmitted by the generative AI system based on the chat message transmitted to the generative AI system, the information related to the application, and the information for calling the function, the request including the data generated by the generative AI system based on the chat message and the information related to the application, the data registration unit registers the data included in the received request in the application in which the data is to be registered.

### Aspect 2

In the information processing apparatus according to Aspect 1, when the chat control unit receives the request from the generative AI system, the chat control unit transmits a request for confirmation of registration of the data included in the received request in the application to the terminal device. When the terminal device receives an instruction to register the data included in the request in response to the request for confirmation displayed on the same screen as the chat message, the chat control unit receives the instruction from the terminal device. The data registration unit registers the data included in the request received from the generative AI system in the application in which the data is to be registered, in response to receiving the instruction from the terminal device.

### Aspect 3

In the information processing apparatus according to Aspect 1, when the chat control unit receives, from the generative AI system, a reply message to the data transmitted to the generative AI system, the chat control unit transmits the reply message to the terminal device.

### Aspect 4

In the information processing apparatus according to any one of Aspects 1 to 3, when application identification information for identifying the application is received from the terminal device, the data registration unit acquires an item name of the application identified by the application identification information for identifying the application. The chat control unit transmits the acquired item name to the generative AI system as information related to the application in which the data is to be registered. The data registration unit registers the data included in the request in association with the item name in the application in which the data is to be registered.

### Aspect 5

The information processing apparatus according to Aspect 4 communicates with an application service that executes the application via a network. The data registration unit acquires, from the application service, the item name of the application that is identified by application identification information for identifying the application.

### Aspect 6

In the information processing apparatus according to any one of Aspects 1 to 5, the information for calling the function includes setting of a specification of the function to be called by the generative AI system. The request related to registration of the data is included in a function call request for calling the function, which is transmitted to the information processing apparatus by the generative AI system based on the setting of the specification of the function. The chat control unit receives the request for registration of the data from the generative AI system.

### Aspect 7

In the information processing apparatus according to Aspect 4, when the chat control unit receives the request for registration of the data from the generative AI system, the data registration unit registers the data included in the request in the application in which the data is to be registered. When the chat control unit receives a response message to the data, not the request related to registration of the data, from the generative AI system, the chat control unit transmits the response message to the terminal device.

### Aspect 8

In the information processing apparatus according to Aspect 7, when the chat control unit receives the request for registration of the data from the generative AI system, the chat control unit transmits the data to the terminal device before the data registration unit registers the data included in the request in the application. When a notification of registering the data from the terminal device is received, the data registration unit registers the data included in the request in the application.

### Aspect 9

In the information processing apparatus according to any one of Aspects 1 to 8, when the application is an application in which the data is registered in a table, the data is one or more values registered in the table.

### Aspect 10

In the information processing apparatus according to Aspect 9, the one or more values include at least one of a date, a character string, or a numerical value.

### Aspect 11

In the information processing apparatus according to Aspect 5, the data registration unit associates the data with the item name and requests the application service to register the data.

### Aspect 12

In the information processing apparatus according to Aspect 11, the terminal device executes a first web browser that communicates with the application service and a second web browser activated by the first web browser. The information processing apparatus receives the chat message from the second web browser. When the chat control unit receives the request for registration of the data transmitted by the generative AI system, the data registration unit transmits the request for registration of the data to the second web browser. The second web browser transmits the request for registration of the data to the first web browser. The first web browser transmits the request for registration of the data to the application service.

### Aspect 13

In the information processing apparatus according to Aspect 4, the data registration unit acquires the item name and a data format of the application identified by the identification information of the application from the application service. When the chat control unit receives the request transmitted by the generative AI system based on the chat message transmitted to the generative AI system, the item name and the data format which are the information related to the application, and the information for calling the function, the data registration unit associates the data in the data format included in the received request with the item name and registers the data in the application in which the data is to be registered.

### Aspect 14

The information processing apparatus according to Aspect 5 communicates with an application service that executes the application via a network. The data registration unit acquires, from the application service, the item name of the application identified by the application identification information for identifying the application.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The invention claimed is:

1. An information processing apparatus communicably connected with a terminal device and a generative artificial intelligence (AI) system through a network, the apparatus comprising:
processing circuitry configured to:
in response to receiving a chat message from the terminal device, transmit the chat message to the generative AI system;
transmit at least once, to the generative AI system, information related to an application in which data is to be registered and information for the generative AI system to call a function; and
in response to receiving a request transmitted by the generative AI system based on the chat message, the information related to the application, and the information for calling the function, execute the function to register the data in the application, the data being included in the request and generated by the generative AI system based on the chat message and the information related to the application.

2. The information processing apparatus according to claim 1, wherein the processing circuitry is further configured to
in response to receiving the request from the generative AI system, transmit a request for confirming registration of the data in the application to the terminal device,
receive, from the terminal device, an instruction to register the data in response to accepting the request for confirming registration that is displayed on the same screen as the chat message, and
register the data in the application in response to receiving the instruction from the terminal device.

3. The information processing apparatus according to claim 1, wherein the processing circuitry is further configured to
in response to receiving, from the generative AI system, a reply message to the data transmitted to the generative AI system, transmit the reply message to the terminal device.

4. The information processing apparatus according to claim 1, wherein the circuitry is configured to
in response to receiving application identification information for identifying the application from the terminal device, acquire an item name of the application identified by the application identification information,
transmit the acquired item name to the generative AI system as the information related to the application, and
register the data in association with the item name in the application.

5. The information processing apparatus according to claim 4, wherein the circuitry is configured to
communicate with an application service that executes the application via the network, and
acquire, from the application service, the item name of the application that is identified by the application identification information.

6. The information processing apparatus according to claim 1,
wherein the information for calling the function includes setting of a specification of the function to be called by the generative AI system, and
wherein the request transmitted by the generative AI system includes a request for registering the data included in a function call request for calling the function, the request for registering being transmitted to the information processing apparatus by the generative AI system based on the setting of the specification of the function.

7. The information processing apparatus according to claim 4, wherein
in a case where the processing circuitry receives, as the request from the generative AI system, a request for registering the data, the processing circuitry is configured to register the data included in the request in the application in which the data is to be registered, and
in a case where the processing circuitry receives a response message to the data from the generative AI system, the processing circuitry is configured to transmit the response message to the terminal device.

8. The information processing apparatus according to claim 7, wherein
in the case where the processing circuitry receives, as the request from the generative AI system, the request for registering the data, the processing circuitry is configured to transmit the data to the terminal device before registering the data included in the request in the application, and
in response to receiving a notification indicating registration of the data from the terminal device, the processing circuitry is configured to register the data included in the request in the application.

9. The information processing apparatus according to claim 1,
wherein, when the application includes a table in which the data is registered, the data is one or more values registered in the table.

10. The information processing apparatus according to claim 9,
wherein the one or more values include at least one of a date, a character string, or a numerical value.

11. The information processing apparatus according to claim 5,
wherein the processing circuitry is configured to request the application service to register the data in association with the item name.

12. The information processing apparatus according to claim 5, wherein
the processing circuitry is configured to acquire the item name and a data format of the application identified by the application identification information from the application service, and
in response to receiving the request transmitted by the generative AI system based on the chat message, the item name and the data format which are the information related to the application, and the information for calling the function, the processing circuitry is configured to register the data in the data format in the application in association with item name.

13. A data registration system comprising:
a terminal device including terminal circuitry configured to transmit a chat message for registering data to be used by an application; and
an information processing apparatus communicably connected with the terminal device and a generative artificial intelligence (AI) system through a network, the apparatus including processing circuitry configured to:
in response to receiving the chat message from the terminal device, transmit the chat message to the generative AI system;
transmit at least once, to the generative AI system, information related to the application in which data is to be registered and information for the generative AI system to call a function; and
in response to receiving a request transmitted by the generative AI system based on the chat message, the information related to the application, and the information for calling the function, execute the function to register the data in the application, the data being included in the request and generated by the generative AI system based on the chat message and the information related to the application.

14. The information processing apparatus according to claim 13, wherein
the terminal circuitry of the terminal device is configured to execute a first web browser that communicates with an application service and a second web browser activated with the first web browser,
the information processing apparatus is configured to receive the chat message from the second web browser,
in response to receiving a request for registering the data as the request transmitted by the generative AI system, the processing circuitry is configured to transmit the request for registering the data to the second web browser,
the second web browser transmits the request for registering the data to the first web browser, and
the first web browser transmits the request for registering the data to the application service.

15. A data registration method, executed by an information processing apparatus communicably connected with a terminal device and a generative AI system through a network, the method comprising:
in response to receiving a chat message from the terminal device, transmitting the chat message to the generative AI system;
transmitting at least once, to the generative AI system, information related to an application in which data is to be registered and information for the generative AI system to call a function; and
in response to receiving a request transmitted by the generative AI system based on the chat message, the information related to the application, and the information for calling the function, executing the function to register the data in the application, the data being included in the request and generated by the generative AI system based on the chat message and the information related to the application.
